(19) United States
(12) Patent Application Publication
(10) Pub. No.: US 2026/0280651 A1
(43) Pub. Date: Sep. 17, 2026

(54) METHODS FOR TEMPORAL SPATIAL FREQUENCY (TSF) CHANNEL STATE INFORMATION (CSI) COMPRESSION AND FOR TSF PARAMETER DETERMINATION

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Mihaela Beluri, Jericho, NY (US); Tejaswinee Lutchoomun, Montreal (CA); Akshay Malhotra, San Jose, CA (US); Patrick Tooher, Montreal (CA); Ahmet Serdar Tan, London (GB)

(73) Assignee: InterDigital Patent Holdings, Inc., Wilmington, DE (US)

(21) Appl. No.: 19/474,518

(22) PCT Filed: May 8, 2024
(86) PCT No.: PCT/US2024/028283

§ 371 Date: Oct. 10, 2025

Related U.S. Application Data
(60) Provisional application No. 63/465,051, filed on May 9, 2023.

(51) Int. Cl. H04B 7/06; H04L 5/00; H04W 24/10; H04W 72/23

(52) U.S. Cl. CPC H04B 7/0626; H04L 5/0055; H04W 24/10; H04W 72/23

(57) ABSTRACT

A wireless transmit/receive unit (WTRU) receives configuration information. The configuration information is associated with temporal-spatial-frequency (TSF) compression. The WTRU measures channel state information (CSI). The WTRU determines TSF parameters based on the configuration information and the measured CSI. The WTRU calculates a compressed CSI based on the measured CSI and the determined TSF parameters. The WTRU sends the determined TSF parameters and the compressed CSI in a CSI measurement report.

### CROSS-REFERENCE TO RELATED APPLICATIONS

This application claims the benefit of U.S. Provisional Patent Application No. 63/465,051 filed on May 9, 2023, the entire contents of which are incorporated herein by reference.

### BACKGROUND

Herein described are methods for a wireless transmit receive unit (WTRU) to reduce the channel state information (CSI) reporting overhead, e.g., using artificial intelligence/machine learning (AI/ML) models that may leverage the CSI temporal correlation properties.

As described herein, CSI may include at least one of the following: channel quality indicator (CQI), rank indicator (RI), precoding matrix index (PMI), an L1 channel measurement (e.g., reference signal received power (RSRP) such as L1-RSRP and/or signal interface and noise ratio (SINR)), channel state information reference signal (CSI-RS) resource indicator (CRI), synchronization signal physical broadcast channel (SS/PBCH) block resource indicator (SSBRI), layer indicator (LI), and/or any other measurement quantity measured by the WTRU from the configured reference signals (e.g., CSI-RS and/or SS/PBCH block and/or any other reference signal).

### SUMMARY

A wireless transmit/receive unit (WTRU) may receive configuration information. The configuration information may be associated with temporal-spatial-frequency (TSF) compression. The WTRU may measure channel state information (CSI). The WTRU may determine TSF parameters based on the configuration information and the measured CSI. The WTRU may calculate a compressed CSI based on the measured CSI and the determined TSF parameters. The WTRU may send the determined TSF parameters and the compressed CSI in a CSI measurement report.

The configuration information may include an indication of one or more of a maximum TSF buffer size, an initial compression ratio, and/or a metric threshold. The TSF parameters may include one or more of a TSF buffer size, a TSF buffer performance indicator, a TSF buffer state, a compression rate, and/or a CSI input domain. The TSF parameters may be based on a measured correlation metric, a configured threshold, a measure of WTRU speed, and/or a measure of physical downlink shared channel (PDSCH) performance.

The metric threshold may include a measurement of a squared generalized cosine similarity (SGCS) between consecutive samples in the TSF buffer as compared to a TSF SGCS threshold. The metric threshold may include a measurement of a SGCS between first and last samples in the TSF buffer as compared to a TSF SGCS threshold.

The measure of WTRU speed may be based on an estimated Doppler, a feedback delay, and/or a CSI processing time. The measure of PDSCH performance may be based on one or more of a measured block error rate (BLER) or a measured number of consecutive acknowledgments or negative acknowledgments (ACK/NACK). The TSF buffer contains eigenvector samples or full CSI samples. The WTRU may store the measured CSI in a TSF buffer.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of channel state information (CSI) measurement settings.

FIG. 3 depicts an example recurrent neural network (RNN) architecture.

FIG. 4 depicts an example of spatial frequency (SF) compression.

FIG. 5 depicts an example of time spatial frequency (TSF) compression using an RNN autoencoder TSF buffer.

FIG. 6 depicts an example of wireless transmit/receive unit (WTRU) measurements to compute the maximum TSF buffer size.

FIG. 7 depicts a flowchart for WTRU procedures to determine the TSF parameters associated with the TSF compression operation.

FIG. 8 depicts an example of metric and set of thresholds for compression mode determination and/or switching.

FIG. 9 depicts an example procedure associated with determining a compression mode (e.g., when the current mode is SF).

FIG. 10 depicts an example procedure associated with determining a compression mode (e.g., when the current mode is TSF).

FIG. 11 depicts an example WTRU procedure associated with determining a compression mode (e.g., as a function of configured metric, metric threshold, and/or current compression mode).

FIG. 12 depicts an example realization of the hidden state framework.

### DETAILED DESCRIPTION

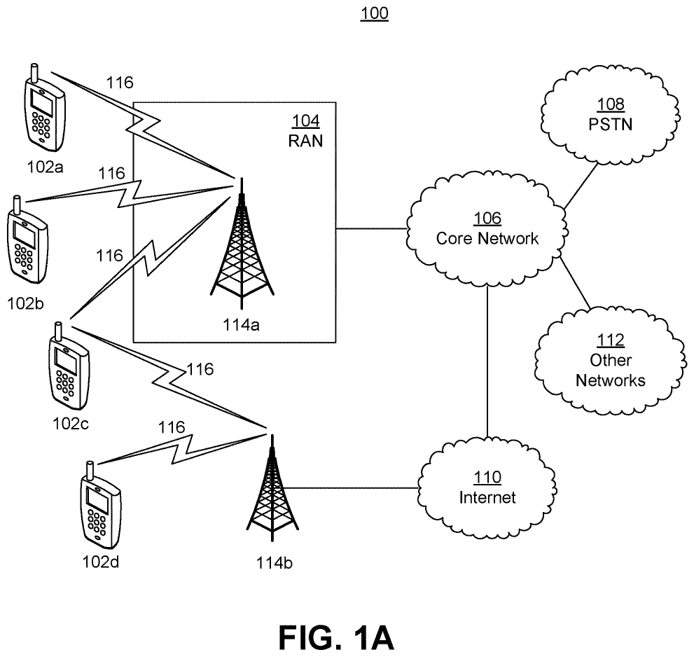

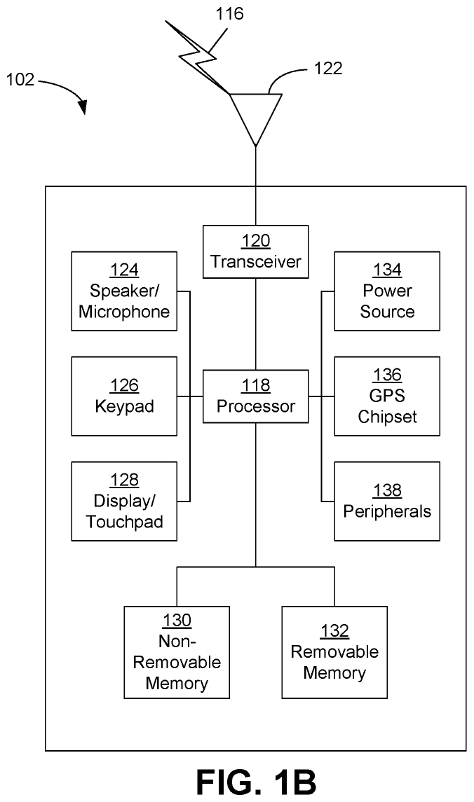

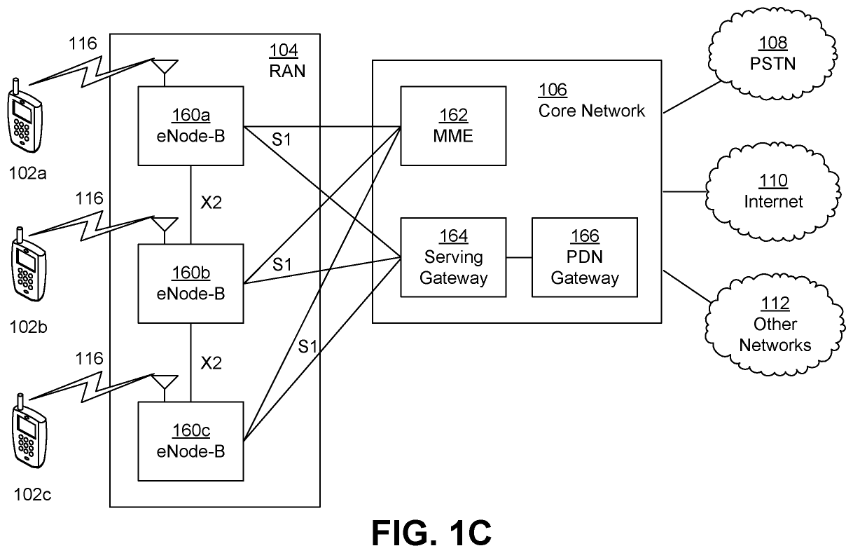

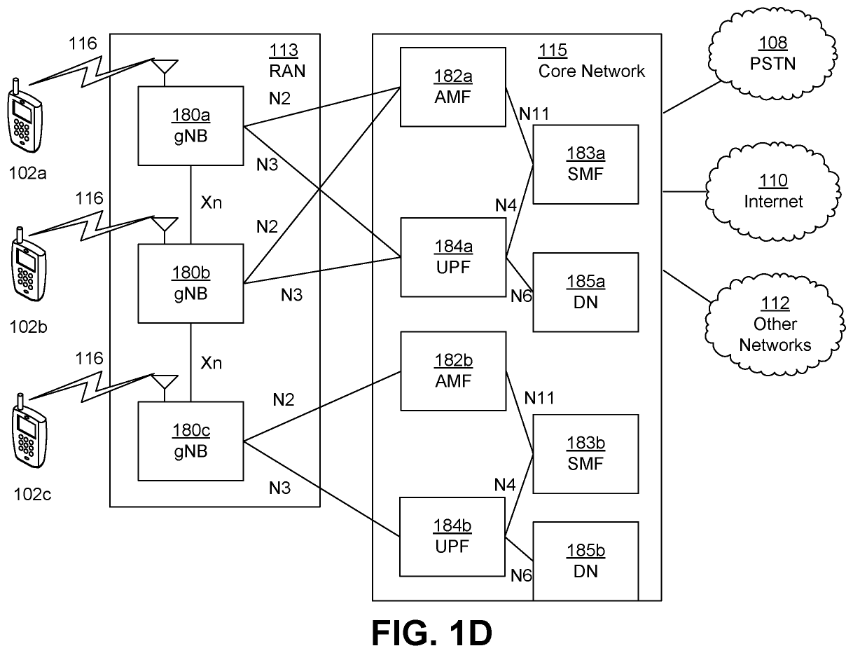

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a“station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c.

The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum.

The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may determine parameters of temporal-spatial-frequency (TSF) compression as a function of channel conditions and/or configured metrics thresholds. The WTRU may report the determined TSF parameters. A WTRU may determine and/or report the next compression mode (e.g., TSF, SF, and/or none) as a function of channel conditions, configured metrics, thresholds, and/or current compression mode. A WTRU performing TSF domain channel state information (CSI) compression, may determine and/or report (e.g., a set of) preferred hidden buffer states as a function of metrics associated with the hidden buffer states and/or channel conditions (including identified blockage events). Procedures for detection and/or mitigation of out-of-sync events (e.g., misalignment between WTRU and/or network (NW) TSF buffers) by WTRUs performing TSF domain CSI compression.

A WTRU may report the CSI through the uplink (UL) control channel on physical uplink control channel (PUCCH), and/or based on (e.g., in response to) the gNBs' request on an UL physical uplink shared channel (PUSCH) grant. Depending on the configuration, channel state information resource signal (CSI-RS) may cover the full bandwidth of a bandwidth part (BWP) and/or just a portion of the BWP. Within the CSI-RS bandwidth, CSI-RS may be configured in each physical resource block (PRB) or every other PRB. In the time domain, CSI-RS resources may be periodic, semi-persistent, and/or aperiodic. Semi-persistent CSI-RS may be similar to periodic CSI-RS, except that the resource may be (de)-activated by medium access control (MAC) control elements (CEs), and/or the WTRU reports related measurements when the resource is activated. For aperiodic CSI-RS, the WTRU may trigger to report measured CSI-RS on PUSCH by request in a downlink control information (DCI). Periodic reports may be carried over the PUCCH. Semi-persistent reports may be carried either on PUCCH and/or PUSCH. The scheduler may use the reported CSI when allocating optimal resource blocks possibly based on channel's time-frequency selectivity, determining precoding matrices, beams, transmission mode, and/or selecting suitable modulation and coding schemes (MCSs). The reliability, accuracy, and/or timeliness of WTRU CSI reports may be critical to meeting ultra reliable and low latency communications (URLLC) service requirements.

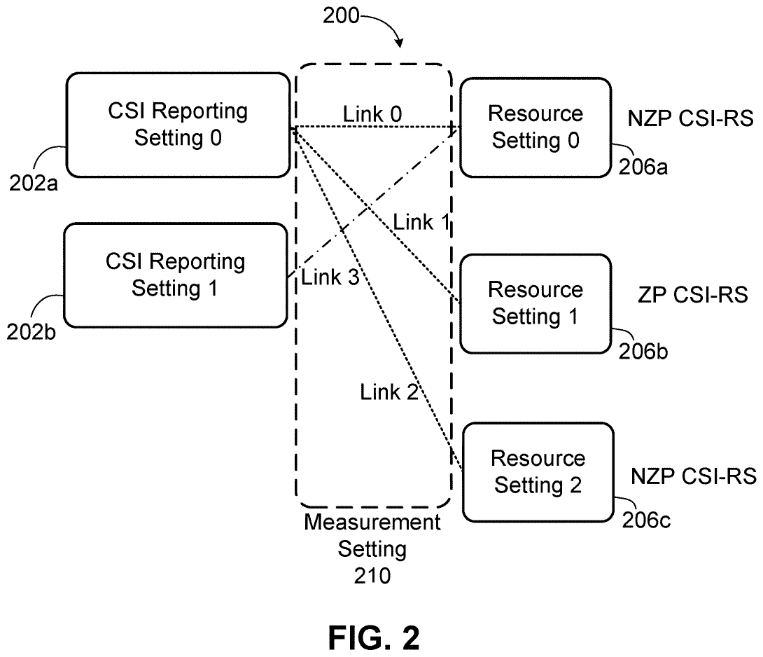

A WTRU may be configured with one or more CSI measurement setting 200. These settings may include one or more CSI reporting settings 202a, 202b, resource settings 206a, 206b, 206c, and/or a link 210 (e.g., association) between one or more CSI reporting settings and/or one or more resource settings. FIG. 2Error!Reference source not found. depicts an example associated with a configuration for CSI reporting settings 202a, 202b, resource settings, and/or a link.

In the CSI measurement setting 200, one or more of the following configuration parameters may be provided: N21 CSI reporting settings, M≥1 resource settings 206a, 206b, 206c, and/or a CSI measurement setting link 210 which links the N CSI reporting settings 202a, 202b with the M resource settings 206a, 206b, 206c.

A CSI reporting setting 202a, 202b may include at least one of the following settings: time-domain behavior: aperiodic and/or periodic/semi-persistent; frequency-granularity, at least for precoding metric indicator (PMI) and/or channel quality indicator (CQI); CSI reporting type (e.g., PMI, CQI, RI, and/or CSI reference signal resource indicator (CRI), etc.); and/or PMI type (e.g., type I and/or type II) and/or codebook configuration if a PMI is reported.

A resource setting 206a, 206b, 206c may include at least one of the following settings: time-domain behavior, e.g., aperiodic and/or periodic/semi-persistent; reference signal (RS) type (e.g., for channel measurement and/or interference measurement); and/or S≥1 resource set(s) and/or each resource set can include Ks resources.

A CSI measurement setting 200 may include at least one of the following settings: one CSI reporting setting 202a, 202b; one resource setting 206a, 206b, 206c; and/or for CQI, a reference transmission scheme setting.

For CSI reporting for a component carrier, one or more of the following frequency granularities may be supported: wideband CSI, partial band CSI, and/or sub band CSI.

Artificial intelligence may be broadly defined as the behavior exhibited by machines. Such behavior may, e.g., mimic cognitive functions to sense, reason, adapt, and/or act. The terms artificial intelligence (AI), machine learning (ML), deep learning (DL), and/or deep neural networks (DNNs) may be used interchangeably. Methods described herein may be based on learning in wireless communication systems. These methods may not be limited to such scenarios, systems, and/or services and/or may be applicable to any type of transmissions, communication systems and/or services, etc.

Auto-encoders (AE) may be a specific class of DNNs that arise in context of unsupervised machine learning setting wherein high-dimensional data may be non-linearly transformed to a lower dimensional latent vector using a DNN based encoder. The lower dimensional latent vector may then reproduce the high-dimensional data using a non-linear decoder. The encoder may be represented as E(x; Wₑ) where x is the high-dimensional data and Wₑ may represent the parameters of the encoder. The decoder may be represented as D (z; W_{d}) where z may be the low-dimensional latent representation and W_{d} represents the parameters of the decoder. Further, using training data {x₁, . . . , x_{N}} the auto-encoder may be trained by solving the following optimization problem:

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem may be approximately solved using a backpropagation algorithm. The trained encoder

$$E ( x ; {W}_{e}^{t r} )$$

may compress the high-dimensional data. The trained decoder

$$D ( z ; {W}_{d}^{t r} )$$

may decompress the latent representation.

Recurrent neural networks (RNN) may have recently emerged as a popular approach for handling problems with time series data due to their power in uncovering complex relationships between temporal components in a given sequence. RNNs may be another class of DNNs consisting of an input layer, an output layer, and/or one or more hidden layers. The hidden layers may leverage memory of previous states to perform compression and/or prediction tasks.

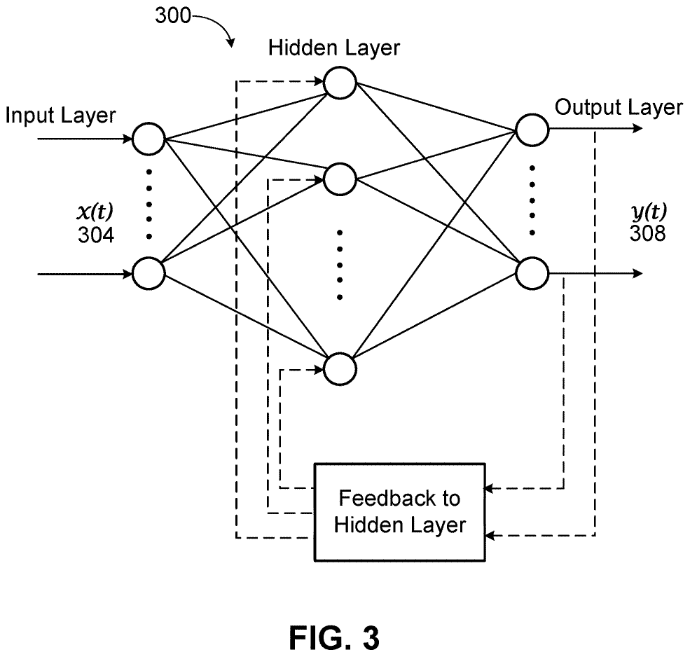

FIG. 3 depicts an example RNN architecture 300. As illustrated in FIG. 3, the vector of hidden states may be a function of current inputs and/or previous RNN output, x, also referred to herein as x(t), represents the at the RNN input vector 304 at time t, and/or y, also referred to herein as y(t) represents the RNN output vector 308 at time t.

An RNN may perform CSI compression tasks. When the RNN is used for channel/CSI compression, the input x 304 may consist of a sequence of N previous consecutive channel estimates represented by:

$$\tilde{H} ( t ) , \tilde{H} ( t - 1 ) , … \tilde{H} ( t - N + 1 ) .$$

To generate the RNN input, the estimated channel and/or CSI may be fed to a tapped delay line. Moreover, depending on the RNN architecture, the input sequence of N channel estimates may be converted from matrix to vector form. For an AE model with RNN structure, the encoder output may represent the latent compressed channel and/or CSI at time t, (e.g., zₜ), generated based on a sequence of input channel samples. The decoder output may represent the decompressed channel at time t given the latent zₜ along with the N previous consecutive decompressed channel estimates represented by:

$$\hat{H} ( t - 1 ) , … \hat{H} ( t - N + 1 ) .$$

An example of loss function used to train the RNN is

$$ℒ = {‖ \hat{H} ( t ) - H ( t ) ‖}_{F}^{2} ,$$

where Ĥ(t) represents the output of the decoder at time t, H(t) represents the desired output of the network (e.g., the actual channel at time t), and/or the operator ∥.∥_{F} indicates the Frobenius (e.g., Euclidean) norm.

Machine learning based approaches (e.g., AE) may be used to balance CSI feedback overhead and/or reconstruction performance. Certain machine learning techniques may rely on spatial-frequency (SF) CSI compression (e.g., using the estimated channel sample at a given time). SF compression may provide acceptable reconstruction quality. The reconstruction quality performance may be improved. The reconstruction quality may approach the performance of uncompressed CSI.

The performance of CSI compression may be improved by leveraging the correlation properties of the channel in the compression process. For example, the CSI temporal correlation may be exploited on the top of SF compression, which may improve the reconstruction performance for a given overhead, reduce the overhead for a given performance, and/or improve performance and/or overhead relative to the SF compression.

However, to optimize the performance of the time-spatial-frequency (TSF) approach, the encoder and/or decoder may need to operate in a synchronous mode (e.g., the RNN encoder and/or decoder parameters (e.g., buffer size) are matched). The techniques described herein may be used to provide seamless and/or efficient TSF operation.

The following problems may be addressed: for an AE with RNN architecture at both encoder and decoder, how to adapt the number of temporal samples in the encoder and/or decoder to achieve a target performance; how to determine which compression mode (TSF, SF, none) to use; how to determine and indicate the TSF parameters (e.g., number of buffer samples (N), buffer state, compression rate (CR), etc.) associated with the TSF compression mode(s); how to revisit and/or indicate a particular hidden state in the encoder and/or decoder buffer to maintain a target performance; how to maintain the synchronous operation of the RNN AE by detecting/minimizing the out-of-sync events (e.g., synchronization loss between the RNN encoder and decoder), and/or how to mitigate the associated impacts.

Although examples described herein are in the context of recurrent neural networks (RNNs), the techniques are generally applicable to any type of artificial intelligence/machine learning (AI/ML) model including, but not limited to, long short-term memory (LSTM), gated recurrent units (GRU), attention-based models (e.g., transformers), and/or AE models (e.g., variational autoencoders, conditional variational autoencoders, etc.).

An RNN AE may include an AE model with RNN based architecture at the encoder and/or decoder parts of the AE model. The encoder and/or decoder may be referred to as RNN encoder and/or RNN decoder. The RNN architecture may be used to incorporate the past and/or historical samples in the compression and decompression tasks.

SF compression may include a compression technique that compresses the current CSI sample (e.g., raw channel and/or eigenvector) using an encoder model at the WTRU, and/or uses the compressed CSI to recover the decompressed CSI using a decoder model at the gNB.

TSF compression may include a compression technique that utilizes at least past and/or historical CSI samples (e.g., raw channel and/or eigenvector) along with the current CSI sample(s) at the WTRU to generate the current compressed CSI using RNN encoder. TSF compression may further include at least one past and/or historical decompressed CSI sample along with the current compressed CSI at the gNB to generate and/or recover the current decompressed CSI using the RNN decoder.

Modes may be used to distinguish between the different compression techniques. For example, the compression mode may be TSF, SF, and/or another compression type (e.g., CSI type I codebook and/or CSI type II codebook).

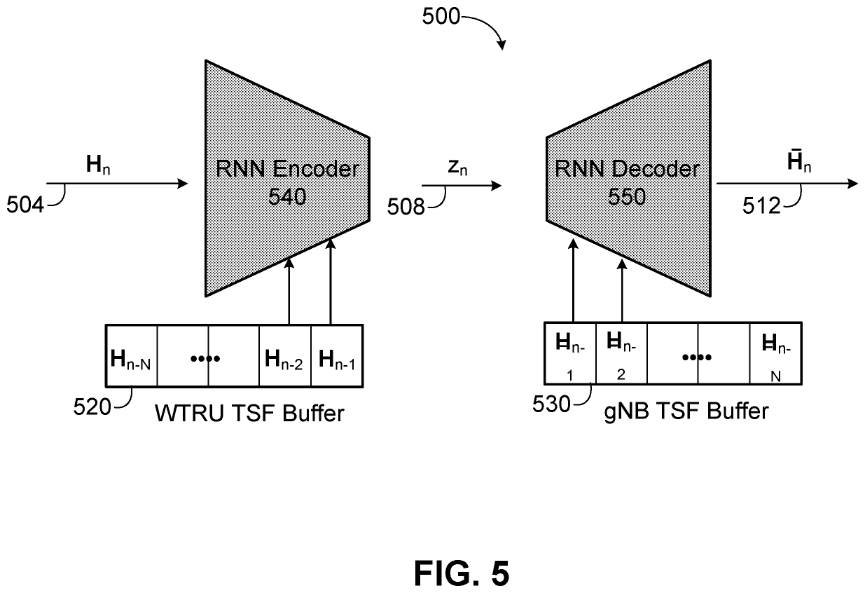

The term TSF buffer may refer to the buffer used at the WTRU to store the past CSI samples (e.g., raw channel and/or eigenvector) and/or the buffer used at the gNB to store the past decompressed CSI samples. The term WTRU TSF buffer may also be used to refer to the TSF buffer at the WTRU. The term gNB TSF buffer may also be used to refer to the TSF buffer at the gNB, as shown in FIG. 5. The terms TSF buffer and TSF history buffer may be used interchangeably herein.

The term hidden state X may refer to an internal and/or hidden state of the RNN encoder and/or RNN decoder that includes an intermediate representation of a sequence of X historical samples. For example, given a sequence of CSI samples H(5), H(4), . . . H(1) collected across five time slots, the hidden state 5 may include the information associated with h_{S}, which may serve as an intermediate representation of the channel samples collected up to slot 5.

A TSF hidden buffer may refer to the buffer used at the WTRU to store the information associated with one or more of the hidden states. A TSF hidden buffer may refer to the buffer used at the gNB to store the information associated with the hidden states representing a sequence of decompressed CSI samples.

RNN AE synchronous operation may refer to a synchronized operation between the RNN encoder and/or the RNN decoder. Synchronization between the RNN encoder and/or RNN decoder may include one or more of the following: the RNN encoder and/or decoder TSF buffers are synchronized, (e.g., the same number and/or indices of historical samples may be stored and used during inference at both WTRU and/or gNB); and/or the RNN encoder and/or decoder hidden buffers may be synchronized, (e.g., the same hidden state indices may be stored in the two hidden buffers and/or the same state index may be used during inference at both sides). Out-of-sync events may refer to the loss of synchronization between the RNN encoder and/or RNN decoder.

For example, when there is any misalignment in the TSF buffers and/or TSF hidden buffers, an out-of-sync event may occur (e.g., the RNN encoder and/or RNN decoder may be out-of-sync).

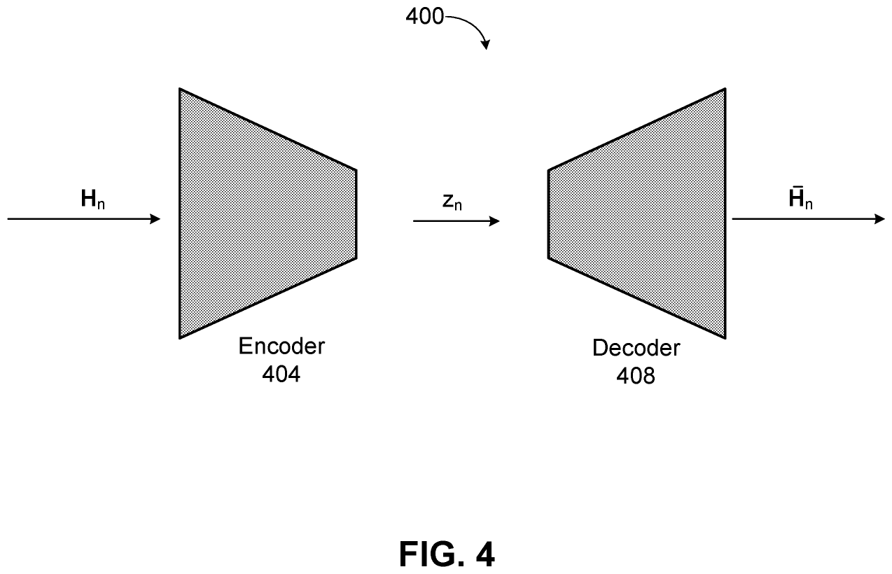

Spatial frequency (SF) compression may operate on a sample-by sample basis. A WTRU may use an AE model to perform compression at time slot n, e.g., based on the estimated channel Hₙ. In examples, the WTRU may compress (e.g., first compress) Hₙ using an encoder model to generate and/or send back the latent representation (e.g., compressed CSI) zₙ. The gNB may use the decoder model to decompress the received latent zₙ to recover H̅ₙ. The difference and/or distance between the estimated channel Hₙ at the WTRU and the recovered and/or decompressed channel at the gNB may represent the compression loss. FIG. 4 depicts an example diagram 400 of the SF compression.

Certain encoder 404 and/or decoder 408 models may incorporate historical time samples. In such a case, for example, AE models may be referred to as RNN autoencoder (e.g., where both encoder 404 and/or decoder 408 may have RNN architecture). Such a compression mode may be referred to as TSF compression.

In TSF compression, past samples may be used as an input along with the current sample as shown in the diagram 500 in FIG. 5. As illustrated in FIG. 5, the CSI temporal correlation properties may be leveraged to further improve the compression performance. The compression performance may improve from an overhead reduction perspective for a given reconstruction performance, from a reconstruction performance perspective for a given overhead, and/or by achieving gains in both overhead reduction and/or reconstruction performance.

As further described herein, TSF may leverage the CSI temporal correlation properties to enable high compression capabilities relative to the SF and/or other compression techniques (e.g., CSI type I codebook and/or CSI type II codebook) for a given target performance. TSF may leverage the CSI temporal correlation properties which may improve the performance of SF and/or other compression techniques at a given compression rate. TSF may provide both performance and/or overhead reduction gains relative to SF and other compression techniques.

TSF may provide dynamic adaptation and/or flexible use of the past historical samples to balance between performance, complexity, overhead, and/or storage.

A WTRU may determine parameters of temporal-spatial-frequency (TSF) compression as a function of channel conditions and/or configured metrics thresholds and/or reports the determined TSF parameters. A WTRU may determine and/or report the next compression mode (e.g., TSF, SF, and/or none) as a function of channel conditions, configured metrics, thresholds, and/or current compression mode. A WTRU performing TSF domain channel state information (CSI) compression, determines and/or reports (e.g., a set of) preferred hidden buffer states as a function of metrics associated with the hidden buffer states and/or channel conditions (including identified blockage events). Procedures for detection and mitigation of out-of-sync events (e.g., misalignment between WTRU and/or network (NW) TSF buffers) by WTRUs performing temporal-spatial-frequency (TSF) domain CSI compression.

A WTRU may determine the parameters associated with TSF compression, e.g., as a function of channel conditions and/or configured metrics thresholds. The WTRU may report the determined TSF parameters (e.g., to the network, for example, to maintain synchronicity).

The WTRU, in a system using two-sided models for CSI compression, may perform TSF domain compression. The TSF configuration may include one or more TSF parameters, such as: maximum TSF buffer size for past CSI, where the TSF buffer includes historical CSI (e.g., eigenvector samples and/or full CSI samples); initial compression ratio (e.g., if two or more RNN encoders are used); and/or metric threshold for use of TSF (e.g., TSF squared generalized cosine similarity (SGCS)). The WTRU may measure the CSI and/or store the measured CSI (e.g., full channel) in the TSF buffer.

The WTRU may determine the TSF parameters. The TSF parameters may include: the TSF maximum buffer size; TSF buffer performance indicator for each size (e.g., SGCS); TSF buffer state; selected compression rate; metric (e.g., SGCS); and/or input domain (e.g., eigenvector versus CSI). For example, the WTRU may determine the TSF parameters based on one or more of the following: metric threshold, WTRU speed, and/or PDSCH performance.

As described herein, the WTRU may determine TSF parameters based on a metric threshold. In such case, the WTRU may measure the SGCS between consecutive samples and/or measure the SGCS between the first and/or last samples in the TSF buffer. The WTRU may compare the SGCS to the configured TSF SGCS threshold.

As described herein, the WTRU may determine TSF parameters based on the WTRU's speed. In such case, the WTRU may determine the maximum buffer size based on the estimated Doppler, feedback delay and/or CSI processing time.

As described herein, the WTRU may determine TSF parameters based on the PDSCH performance. In such case, the WTRU may update TSF parameters (e.g., reduce compression ratio) if block error rate (BLER) exceeds a certain configured threshold.

The WTRU may calculate the compressed CSI using the determined parameters (e.g., TSF buffer size and/or selected compression ratio). The WTRU may report the determined TSF parameters (e.g., TSF buffer size, TSF buffer performance indicator, selected compression rate, input domain, and/or TSF buffer state) and/or the compressed CSI.

For TSF parameters determination, the WTRU may be configured for TSF based compression. The WTRU may employ the RNN AE model configuration with possibly multiple RNN encoders and/or decoders trained together. A WTRU may determine and/or derive and report one or more quantity of CSI report (e.g., PMI) using a two-sided RNN autoencoder model.

The WTRU may be configured with the RNN AE model parameters. For example, the RNN AE model may comprise one or more RNN encoder models (e.g., Kₑ) and/or one or more RNN decoder models (e.g., K_{d}) to support multiple resolutions (e.g., feedback sizes), such as {αₘ} for m=0, . . . , M−1, where α₀≤ . . . ≤α_{M-1}, and M≤max(Kₑ, K_{d}). The WTRU may be configured with the initial and/or minimum compression ratio (e.g., α₀) to generate the compressed CSI. The WTRU may be explicitly indicated and/or configured with the RNN encoder to use for compression. The WTRU may implicitly apply one of the configured RNN encoders based on the indicated compression ratio. The WTRU may be configured with the RNN AE input domain (e.g., full CSI and/or eigenvector).

The WTRU may employ the temporal-spatial-frequency (TSF) parameters configuration. The WTRU may be indicated to use the configured RNN AE model for TSF compression. The WTRU may determine whether to use TSF compression for CSI feedback based on an indication in a DCI field and/or based on one or more configuration elements in the radio resource control (RRC) signaling and/or MAC CE. When configured to use TSF compression, the WTRU may start storing the estimated CSI samples and/or possibly a preprocessed CSI (e.g., eigenvector).

The TSF compression parameters may include TSF compression activation. This parameter may take a binary value indicating the TSF compression operation. For example, if set to ‘1’, the WTRU may store estimated CSI samples to be used for compression in the next time slots.

TSF buffer parameters may include one or more of the following: the gNB max TSF buffer size parameter, which the gNB may indicate the maximum possible TSF buffer size used at the gNB. The WTRU may use this parameter to determine its TSF buffer size. For example, the WTRU may choose the TSF buffer size to be at most the same as the gNB max TSF buffer size.

The WTRU maximum TSF buffer size may indicate the WTRU maximum possible TSF buffer size based on WTRU capability.

The WTRU preferred TSF buffer size parameter may indicate the preferred and/or recommended TSF buffer size to use. This parameter may be chosen to be less than or equal to the minimum of gNB max TSF buffer size and/or WTRU maximum TSF buffer size.

The TSF buffer CSI type/input domain parameter may indicate the CSI type used in the TSF buffers at the WTRU and/or gNB. For example, the type may include full CSI samples (e.g., three dimensional samples with number of receive and/or transmit antennas along with the number of subbands). The type may include eigenvector samples. The terms CSI type and CSI input domain may be used interchangeably.

The TSF buffer performance indicator parameter may indicate the degree of correlation between the CSI samples in the gNB TSF buffer if configured by gNB, and/or the WTRU TSF buffer if indicated by the WTRU. For example, this correlation may include the quantized SGCS between the last two newest samples in the buffer. This may be the cosine similarity between the first and last sample in the buffer.

The TSF buffer counter/state parameter may indicate the number of current temporal samples in the TSF buffer. For example, this parameter may assist the WTRU and/or gNB to keep the TSF buffers synchronized.

The TSF initial compression rate may indicate the initial compression rate to apply when the TSF compression is activated. The TSF performance threshold may describe when to configure the WTRU with a threshold (or a set of thresholds) to monitor and/or determine TSF compression performance. For example, the threshold may represent the minimum required correlation between each temporal sample in the TSF buffer. In another example, the threshold may assist the WTRU with determining one or more parameters of the TSF compression (e.g., WTRU TSF buffer size).

A WTRU may perform procedures for TSF compression and/or parameters determination. The WTRU may operate with TSF compression. The compressed CSI at time slot n may be based on the estimated channel at time slot n along with one or more (e.g., N) historical samples.

Referring again to FIG. 5, the WTRU may apply the following procedures for TSF compression.

At the initial state and/or time slot n₀ (e.g., no historical samples of TSF compression, TSF buffer 520 is empty, etc.), the WTRU may apply the following steps: the WTRU may estimate CSI 504 (e.g., full channel H₀∈C^{N}^{ᵣ}^{×N}^{ₜ}^{×N}^{_{c}}) using the configured CSI-RS resources, where Nᵣ, Nₜ, N_{c} are the number of receive antennas, number of transmit antennas, and number of subbands, respectively, If configured, the WTRU may preprocess the estimated CSI (e.g., deriving one or more eigenvectors) before applying the compression. The WTRU may then update the TSF buffer 520 using the configured TSF parameters (e.g., stores the estimated CSI H₀ 504 and updates the buffer counter). The WTRU may then compress the estimated CSI sample 504 (e.g., full channel H₀∈C^{N}^{ᵣ}^{×N}^{ₜ}^{×N}^{_{c}}) with the configured initial compression ratio (α₀), to obtain the compressed CSI z₀ 508 along with the hidden state information

$${h}_{0}^{e} .$$

Both the compressed CSI 508 and the hidden state information may be the outputs of the RNN encoder 540 used by the WTRU:

$$( {z}_{0} , {h}_{0}^{e} ) = {f}_{e} ( {H}_{0} ; {θ}_{e} ) ,$$

where ƒₑ(.) is the trained RNN encoder 540 and θₑ represents the trainable RNN encoder 540 parameters. The WTRU may then signal back the compressed channel z₀ 508 along with any updated TSF parameters (e.g., WTRU maximum and/or TSF buffer 520 size).

The NW may then use the received CSI report (e.g., compressed information z₀) to generate and/or recover the decompressed channel H̅₀ 512 along with the hidden state information

$${h}_{0}^{d}$$

using the RNN decoder 550, e.g.,

$$( {\overline{H}}_{0} , {h}_{0}^{d} ) = {f}_{d} ( {z}_{0} ; {θ}_{d} ) ,$$

where ƒ_{d}(.) is the trained RNN decoder 550 and θ_{d} represents the trainable RNN decoder parameters. The gNB may update the TSF buffer 530 parameters (e.g., store H̅₀) and/or update the buffer counter.

Then, for every subsequent slot n₀+n where n∈{1, . . . , N}, the WTRU may repeat the previous procedures with possibly some updates to the TSF parameters. For example, at time slot 1, (e.g., n₀+1) the WTRU may estimate the channel H₁ and/or may apply the TSF compression using the stored samples in the buffer (e.g., H₀) along with the current estimated channel H₁. The WTRU may apply the TSF compression with the same or different (e.g., higher) compression rate (αₘ), for m=0, . . . , M−1, based on channel conditions (e.g., temporal correlation between H₀ and H₁). The WTRU may apply a higher compression rate if the correlation between the previous and current channel samples exceeds the configured correlation threshold. The WTRU may update the TSF buffer (e.g., storing the sample H₁ and/or update the buffer counter). The WTRU may also obtain the hidden state information

$${N}_{max} = ⌊ \frac{{cT}_{c}}{{t}_{ce} + δ {t}_{f}} ⌋$$

at time slot 1 along with the compressed channel z₁. The WTRU may then send the compressed channel information along with the updated TSF buffer parameters (e.g., counter) and selected or recommended compression rate.

Similarly, gNB may use the CSI feedback information z₁ along with the stored decompressed sample in the buffer H̅₀ to recover the channel sample H̅₁. The gNB may then update the TSF parameters (e.g., TSF buffer and counter) for the next TSF compression.

The WTRU may determine one or more parameters associated with the TSF compression. The TSF parameters may include the maximum TSF buffer size (N) supported by the WTRU, the CSI type or input domain (e.g., full CSI or eigenvector), the TSF buffer counter, and/or TSF compression ratio.

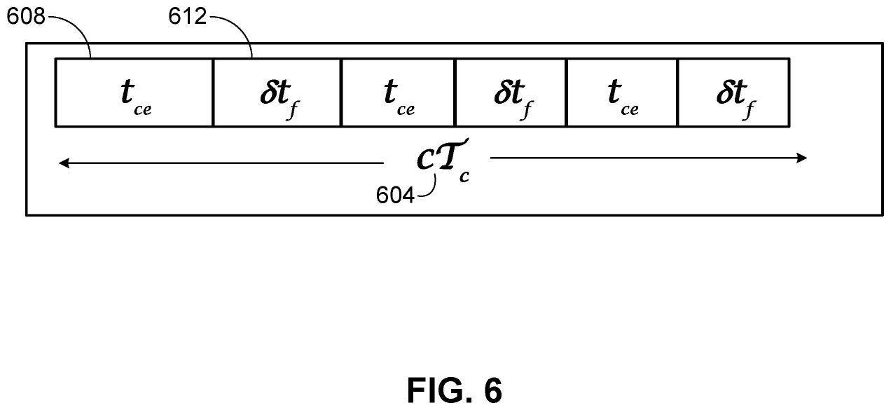

To determine the maximum TSF buffer size, the WTRU may determine and/or report the maximum TSF buffer size as a function of the channel parameters (e.g., Doppler and/or coherence time). For example, as shown in FIG. 6, the WTRU may determine the maximum TSF buffer size (Nₘₐₓ) as a function of the coherence time (T_{c}) of the channel or possibly a factor of the coherence time (e.g., cT_{c} 604 where c≥1), where the factor c may be configured by the gNB.

Specifically, the WTRU may compute the maximum buffer size based on the following relation,

$${N}_{max} = ⌊ \frac{c {T}_{c}}{{t}_{c e} + δ {t}_{f}} ⌋$$

where └.┘ denotes the floor operator. The term t_{ce} 608 represents the time required to estimate and/or compress the CSI while δt_{ƒ} 612 represents the time required to feed back the estimated channel (e.g., feedback delay). FIG. 6 shows an example of the WTRU measurements to compute the maximum TSF buffer size.

In examples, the WTRU may determine the maximum TSF buffer size based on correlation measurements. For example, when the WTRU starts the TSF compression, the WTRU may measure the correlation performance (e.g., SGCS) between the first two collected samples in the buffer (e.g., H₀ and H₁). The WTRU may determine and/or estimate the maximum buffer size based on the gap between the configured correlation threshold (e.g., ρₜₕ) and the measured correlation between H₀ and H₁ (e.g., ρₘ). For example, if ρ_{g}=ρₘ−ρₜₕ is negative, then the WTRU may indicate the minimum possible maximum buffer size (e. g., N=1), otherwise, the WTRU may dynamically indicate the maximum buffer size based on a mapping between ρ_{g} and maximum buffer size.

The WTRU may measure the correlation (e.g., ρₘ) in the latent space (e.g., between z₀ and z₁). The WTRU may estimate the maximum buffer size based on the gap between the measured correlation and the configured threshold. Measuring the correlation in the latent space may result in memory and/or computational savings compared to the full channel space.

The WTRU may determine the maximum buffer size based on iterative measurements of the correlation between the first and last samples in the TSF buffer. For example, the WTRU may measure the correlation between the first sample in the buffer Hₙ_{₀} and the last stored sample at time n, e.g., Hₙ where n>n₀, as

$${ρ}_{m}^{n} = f ( {H}_{{n}_{0}} , {H}_{n} )$$

where f(.) represents the correlation function (e.g., SGCS).

The WTRU may determine the maximum buffer size by comparing the measured correlation with a configured correlation threshold. For example, the WTRU may determine the buffer size Nₘₐₓ=n−n₀−1 where the measured correlation

$${ρ}_{m}^{n}$$

drops below the configured threshold at time n.

The WTRU may determine the CSI input domain to use in the TSF buffer. For example, at the initial operation of the TSF compression, the WTRU may measure the correlation between the first two full channel samples in the buffer as

$${ρ}_{f} = f ( {H}_{0} , {H}_{1} )$$

where ƒ(.) represents the correlation function (e.g., SGCS). The WTRU may also measure the correlation in the eigenvector domain as

$${ρ}_{E {V}^{=}} f ( {V}_{0} , {V}_{1} )$$

where V₀ and V₁ denote the eigenvectors associated with the full channel matrices H₀ and H₁, respectively.

The WTRU may select the CSI input type that results in higher correlation. For example, WTRU may select the EV input type if ρ_{EV}>ρ_{ƒ} and the full samples input type otherwise.

The WTRU may be configured with multiple RNN encoders in support of adapting the compression rate based on the monitored TSF performance. The WTRU may dynamically select the TSF compression rate based on one or more criteria described herein. For example, the WTRU may adapt the compression rate based on one or more configured performance thresholds (e.g., SGCS). The WTRU may use the initial compression rate at the initial operation of TSF compression (e.g., the TSF buffer is empty). The WTRU may then adapt the compression rate based on the measured correlation between every two consecutive sample in the buffer or between the first and last samples in the buffer.

The WTRU may adapt the compression rate based on comparing the measured correlation with the one or more configured thresholds. For example, the WTRU may select the compression rate αₘ if the measured correlation falls within the range of the configured thresholds

$${ρ}_{1}^{m} and {ρ}_{2}^{m} ,$$

for m=1, . . . , M. In another example, the WTRU may adapt the compression rate based on a configured PDSCH performance (e.g., BLER threshold and/or number of consecutive acknowledgements (ACKs)). For example, the WTRU may increase the compression rate if the number of observed ACKs exceeds a certain threshold, and/or the WTRU may decrease the compression rate if the number of consecutive negative acknowledgements (NACKs) exceed a certain threshold.

The WTRU may be configured to report one or more parameters associated with TSF compression. The TSF parameters may include one or more of the following: the maximum buffer size; the TSF buffer counter; the initial compression rate; the selected TSF compression rate; TSF performance indicator (e.g., SGCS) associated with the current state of the buffer; TSF buffer CSI type; and/or RNN encoder model ID. Herein such reporting may be referred to as TSF feedback and/or TSF report. The TSF reporting may be considered part of the CSI reporting framework. Such reporting may be periodic, aperiodic, semi-persistent and/or event triggered.

The WTRU may transmit the TSF feedback as part of the CSI report. For example, the CSI report may comprise two parts. The first part may include the determined TSF parameters (e.g., TSF buffer size, TSF performance metric, and/or TSF compression rate). The second part may include the compressed CSI feedback using the RNN encoder model. The WTRU may transmit the CSI feedback along with the TSF parameters feedback via UCI and/or in a PUSCH resource or in MAC CE. The WTRU may transmit the TSF feedback in a PUSCH resource while the CSI feedback via UCI. The WTRU may transmit some of the TSF parameters (e.g., TSF buffer counter) periodically while other TSF parameters (e.g., TSF buffer size and/or TSF compression rate) may be transmitted semi-persistently (e.g., in a PUSCH resource).

The WTRU may indicate the recommended metrics for TSF compression monitoring (e.g., TSF buffer update). For example, the WTRU may indicate to measure the performance (e.g., SGCS) between each two consecutive sample in the buffer; between the first and last sample in the TSF buffer; and/or the minimum SGCS across every pair of consecutive samples in the TSF buffer. The WTRU may explicitly or implicitly indicate the recommended performance metric. The WTRU may quantize the performance metric (e.g., SGCS) indicated in the TSF feedback. The quantization of the TSF performance metric may be indicated and/or configured by the NW.

The WTRU may explicitly or implicitly indicate the recommended TSF compression rate. For example, the WTRU may adapt the compression rate based on one or more configured performance thresholds (e.g., BLER and/or SGCS). Additionally or alternatively, the WTRU may select and/or indicate the compression rate based on the allocated uplink resource for reporting the compressed CSI. The WTRU may indicate the preferred initial compression rate based on channel measurements (e.g., Doppler).

A WTRU may be indicated to update TSF parameters. The WTRU may operate with TSF domain compression. When operating with TSF compression, the WTRU may use a set of TSF parameters. These TSF parameters may include at least one of: maximum TSF buffer size; TSF buffer performance indicator (e.g., SGCS) for each possible buffer size; selected compression rate; initial compression rate; metric threshold for the use of TSF (e.g., TSF SGCS), AI/ML model index; AI/ML model type; AI/ML model parameters; and/or AI/ML input domain (e.g., eigenvalue and/or CSI).

The gNB may indicate the TSF parameters such as in a DCI, MAC CE, and/or RRC message. For example, the TSF compression configuration may include TSF parameters. The WTRU may determine the TSF parameters for a feedback report in the signal triggering the transmission of the feedback report. The WTRU may be indicated the TSF parameters when configured for periodic CSI reporting, configured and/or triggered for aperiodic CSI reporting, and/or configured and/or triggered for semi-persistent CSI reporting.

The WTRU may determine the TSF parameters based on WTRU measurements. The WTRU may be triggered to determine and/or update TSF parameters. The triggers to determine and/or update one or more TSF parameters may include time; for example, the WTRU may be configured with time instances and/or slots when determining one or more TSF parameters.

The triggers to determine TSF parameters may also include measurement. For example, the WTRU may perform measurements. Based on the measurements achieving certain thresholds and/or criteria, the WTRU may be triggered to determine one or more TSF parameters. The WTRU may measure and/or monitor the TSF buffer performance (e.g., SGCS). When the TSF buffer performance goes below a threshold value, the WTRU may determine one or more TSF parameters. For example, the WTRU may perform measurements to determine WTRU speed, CSI (e.g., long-term and/or short-term CSI), received signal strength indicator (RSSI), reference signal received quality (RSRQ), reference signal received power (RSRP), signal to interface and noise ratio (SINR), channel occupancy (CO), Doppler spread, Doppler shift, Delay spread, Average Delay, angler of arrival (AoA), and/or angle of departure (AoD). Based on the values obtained for one of these measurements, the WTRU may be triggered to determine one or more TSF parameters.

The WTRU may determine the achievable compression rate using a first set of TSF parameters (e.g., TSF SGCS between consecutive samples). If the compression rate goes above and/or below a threshold, the WTRU may determine a new set of one or more TSF parameters.

The triggers to determine TSF parameters may include change of scenario and/or environment. When a WTRU determines and/or is indicated a change in scenario and/or configuration, the WTRU may determine one or more TSF parameters. Changes in scenarios may include changes at least one of: wireless channel type (e.g., indoors or outdoors), line of sight/non-line of sight (LOS/NLOS) environment, and/or WTRU mobility (e.g., WTRU speed). Changes in configuration may include changes to at least one of: beam-pair and/or UL beams and/or DL beams, operating frequency, bandwidth part (BWP), and/or activation/deactivation of cells.

The triggers to determine TSF parameters may include performance of an associated function. For example, the WTRU may determine the performance of DL transmissions (e.g., the rate of HARQ-NACK). If the performance goes below a threshold, the WTRU may determine one or more TSF parameters. In examples, the associated function may be a predictive function (e.g., predicted CSI and/or predicted beam). The WTRU may determine the prediction performance. The WTRU may determine one or more TSF parameters if the prediction performance goes below a threshold value.

The triggers to determine TSF parameters may be based on the priority of an associated transmission. For example, the WTRU may determine one or more TSF parameters based on the priority of an associated transmission. The WTRU may determine one or more TSF parameters when a priority changes (e.g., changed from a previous transmission). The priority may be that of the feedback report and/or that of an associated transmission.

The triggers to determine TSF parameters may be based on the status of a previous feedback. For example, the WTRU may be triggered to determine one or more TSF parameters based on if a previous feedback were dropped (e.g., due to a collision with a higher priority transmission), multiplexed (e.g. multiplexed with another feedback report and/or with data), and/or received at the gNB with error (e.g., based on a CRC check and/or based on a validation of gNB decoding of the feedback).

The triggers to determine TSF parameters may be based on feedback resource selection, or feedback resource, and/or change thereof.

The triggers to determine TSF parameters may be based on the feedback payload. For example, the WTRU may determine one or more TSF parameters if a feedback payload changes (e.g., from a previous feedback transmission). The WTRU may determine one or more TSF parameters if a feedback report uses multiplexing (e.g., with another feedback report) and/or dropping.

The triggers to determine TSF parameters may include detection of an out-of-sync event. For example, a WTRU may determine one or more TSF parameters if the WTRU has determined an out-of-sync event occurred and/or if the WTRU has indicated that an out-of-sync event has occurred. Out-of-sync events are described herein.

The triggers to determine TSF parameters may include AI/ML model performance monitoring. For example, a WTRU may determine one or more TSF parameters if the AI/ML model performance has changed (e.g., by more than a threshold value). For example, if an AI/ML convergence parameter has changed by more than a threshold value, the WTRU may update one or more TSF parameters.

The triggers to determine WTRU may determine TSF parameters when AI/ML model training, re-training, and/or fine-tuning occurs and/or is triggered.

The triggers to determine TSF parameters may be based on one or more hidden buffer states and/or change thereof. A hidden buffer state is described herein.

The triggers to determine TSF parameters may be based on channel occupancy or listen-before-talk (LBT) outcome. For example, a WTRU may determine one or more TSF parameters based on the channel occupancy time (COT) duration and/or timing. For example, based on the time of the LBT and the duration of the COT, the WTRU may determine one or more TSF parameters.

The triggers to determine TSF parameters may be based on the transmission link. For example, the WTRU may determine and/or update one or more TSF parameters based on the link type (e.g., uplink (UL), sidelink (SL), downlink (DL), frequency division duplex (FDD), and/or time division duplex (TDD)) and/or a change thereof.

In addition to being triggers for determining and/or updating one or more TSF parameters, these transmission links may also be triggers for detecting and/or determining whether an out-of-sync event has occurred.

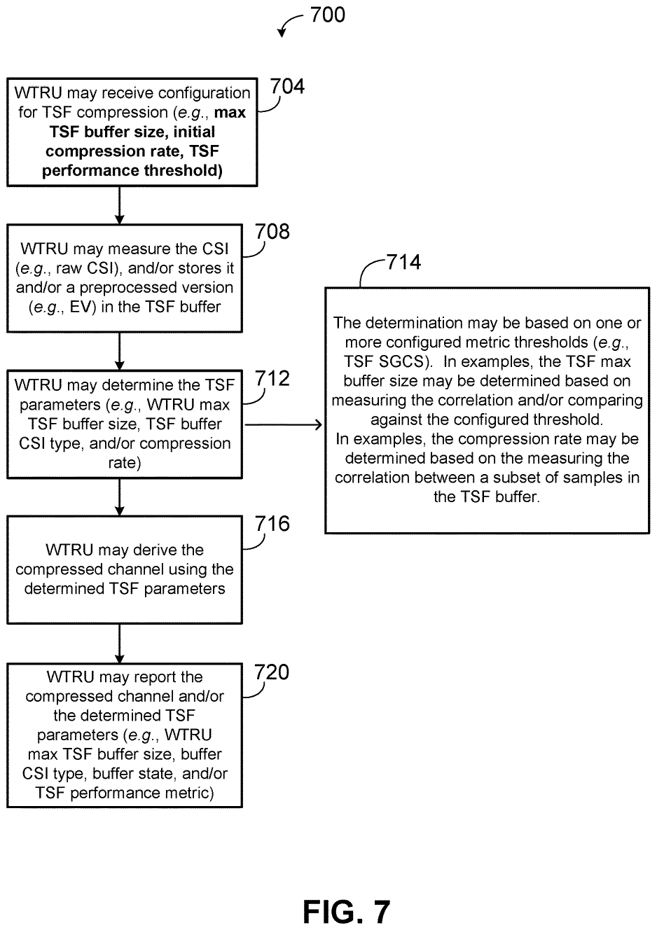

A WTRU in a system 700 using two-sided models for CSI compression may perform temporal-spatial-frequency (TSF) domain compression as seen in FIG. 7. At 704, the TSF configuration may include: maximum TSF buffer size for past CSI, where the TSF buffer contains historical CSI (e.g., eigenvector samples or full CSI samples); initial compression ratio (e.g., if two or more RNN encoders are used); and/or metric threshold for use of TSF (e.g., TSF SGCS).

At 708, the WTRU may measure the CSI. At 708, the WTRU may store the measured CSI (e.g., full channel) in the TSF buffer.

At 712, the WTRU may determine the TSF parameters (e.g., the TSF maximum buffer size, TSF buffer performance indicator for each size (e.g., SGCS), TSF buffer state, selected compression rate, metric (e.g., SGCS), and/or input domain (e.g., EV vs. CSI). At 714, the TSF parameters may be based on one or more metric thresholds. For example, the WTRU measures the SGCS between consecutive and/or between the first and last samples in the TSF buffer and compares the difference to the configured TSF SGCS threshold. The TSF parameters may be based on WTRU speed. For example, determine the maximum buffer size based on the estimated Doppler, feedback delay and CSI processing time. The TSF parameters may be based on PDSCH performance. For example, update TSF parameters (e.g., reduce compression ratio) if BLER exceeds a certain configured threshold.)

At 716, the WTRU may derive the compressed CSI using the determined parameters (e.g., TSF buffer size and/or selected compression ratio).

At 720, the WTRU may report the determined TSF parameters (e.g., TSF buffer size, TSF buffer performance indicator, selected compression rate, input domain, and/or TSF buffer state) and/or the compressed CSI. The WTRU may determine and/or report the next compression mode (e.g., TSF, SF, or none) as a function of channel conditions, configured metrics thresholds, and/or current compression mode.

A WTRU may determine and/or report the next compression mode (e.g., TSF, SF, or none) as a function of channel conditions, configured metrics thresholds, and/or current compression mode.

The WTRU (e.g., a WTRU in a system using two-sided models for CSI compression) may determine the next compression mode (e.g., TSF, SF, or none). For example, the configuration may include: compression mode specific parameters, initial compression ratio, metrics for compression mode determination (e.g. SGCS), and/or a threshold or set of thresholds for compression mode determination (e.g., TSF SGCS).

The WTRU may measure the CSI. The WTRU may perform measurements (e.g., when triggered) for compression mode determination. For example, the WTRU may measure the SGCS between the current sample CSI and/or a previous CSI sample. Additionally or alternatively, the WTRU may measure the SGCS between the first and last CSI samples in the TSF history buffer.

The WTRU may determine the next compression mode (e.g., TSF, SF, or none) as a function of the channel conditions, configured metrics thresholds, and/or the current compression mode. For example, the WTRU may determine the next compression mode as TSF if the current mode is SF and/or the measured performance metric exceeds a first configured threshold. Additionally or alternatively, the WTRU may determine the next compression mode as SF if the current mode is TSF and the measured performance metric is below a second configured threshold. Additionally or alternatively, the WTRU may determine the next compression mode as SF if the WTRU speed exceeds a configured threshold.

The WTRU may calculate the compressed CSI. The WTRU may report the next compression mode and the associated parameters, and/or the compressed CSI.

One or more of the following may apply to the compression mode determination when current mode is SF: The WTRU may measure the CSI. The WTRU may measure the SGCS between the current CSI sample and previous CSI samples. The WTRU may perform CSI compression based on the current compression mode (e.g., SF). On a condition that the measured SGCS exceeds a first threshold, the WTRU may set the next compression mode to TSF. On a condition that the measured SGCS is less than the first threshold, the WTRU may set the next compression mode to SF. The WTRU may report the next compression mode and the compressed CSI.

One or more of the following may apply to compression mode determination when current mode is TSF: The WTRU may measure the CSI. The WTRU may update the TSF history buffer. The WTRU may measure the SGCS between the first and/or last CSI sample in the TSF buffer. On a condition that the measured SGCS is less than a second threshold, the WTRU may reset the TSF history buffer, set the next compression mode to SF, and/or perform the SF mode CSI compression.

On a condition that the measured SGCS may be larger than a second threshold, then the WTRU may set the next compression mode to TSF, perform TSF mode CSI compression, and/or may update the TSF parameters when triggered. The WTRU may report the next compression mode and/or the compressed CSI.

A WTRU capable of performing CSI compression may be configured and/or requested to determine and/or select the compression mode for CSI feedback reporting, via one or more of RRC, MAC CE, and/or DCI.

The configuration for compression mode selection may include a compression mode selection flag. When set, this flag enables the WTRU to perform compression mode selection when triggered and/or indicated by the NW.

The configuration for compression mode selection may include supported compression modes. This indicates to the WTRU the compression modes to be selected from, which may include TSF compression, SF compression, none, and/or another CSI feedback.

The configuration for compression mode selection may include metric for compression performance evaluation. The WTRU may be configured with a metric to measure for compression mode determination/selection, which measures the amount of change in the channel conditions (e.g., at the input of the WTRU-side CSI compression) and/or in the latent space (e.g., at the output of the WTRU-side CSI compression). For example, the metric may be SGCS, normalized mean square error (NMSE), and/or temporal correlation, where the change may be measured between consecutive temporal samples or between different samples in the TSF buffer (e.g., between the first and the last sample in the TSF buffer).

The configuration for compression mode selection may include threshold (e.g., a set of thresholds) for compression mode determination. The WTRU may be configured with a threshold (e.g., or a set of thresholds) associated with the metric for compression performance evaluation. For example, if SGCG is configured as the metric for compression performance evaluation, the threshold (e.g., or set of thresholds) may represent thresholds for SGCS. If temporal cross-correlation is configured as the metric, the thresholds represent temporal correlation thresholds.

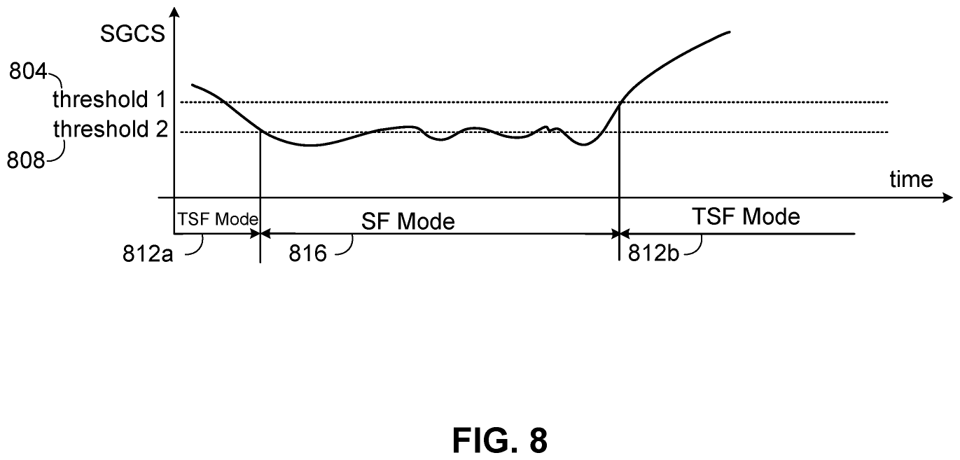

As depicted in FIG. 8, a first threshold 804 (e.g., SGCS threshold) is used for determining the switch from SF 816 to TSF compression mode 812b. A second threshold 808 (e.g., SGCS threshold) is used for determining the switch from TSF 812a to SF compression mode 816. Therein, the second threshold 808 may be smaller than the first threshold 804 (e.g., to prevent excessive switching of the compression mode)Error! Reference source not found..

The configuration for compression mode selection may include initial compression rate. Initial compression rate may be used when the WTRU supports multiple compression RNN models (e.g., of different compression rates).

The configuration for compression mode selection may include compression input type. This indicates to the WTRU whether to compress the full (e.g., raw) channel matrix or the eigenvectors.

The configuration for compression mode selection may include parameters specific to TSF compression and/or parameters specific to SF compression. For TSF compression, the parameters may be the maximum number of historical CSI to use at inference time for TSF compression. These parameters may be smaller than or equal to the max buffer size supported by the WTRU capability. For SF compression, the parameters may include the number of historical CSI to store in the raw buffer. For example, the default value may be 1. In examples, the gNB may configure the WTRU to store more than one historical CSI in the raw buffer, e.g., for optimizing the performance during the switch from SF compression mode to TSF compression mode.

The WTRU may be configured with triggers to perform measurements for determination of the compression mode. The triggers may be based on time and/or indications from the gNB.

For time based triggers, when the WTRU is configured for periodic CSI reporting, the WTRU may measure the configured metric on each configured periodic CSI reference signal. In examples, when the WTRU is configured for semi-persistent CSI reporting (e.g., semi-persistent CSI reporting over PUSCH), the WTRU may measure the configured metric on each configured semi-persistent CSI reference signal.

The WTRU may measure the configured metric as a result of an indication received from the gNB, (e.g., via DCI and/or MAC CE).

The WTRU may be triggered to switch the compression mode when any of the following conditions occur: an update of the CSI-RS configuration, an update of the number of Tx antenna ports, a beam failure detection, a radio link failure detection, and/or handover to a different gNB.

When any of the above conditions occurs, the WTRU may switch the compression mode to SF compression because the historical CSI data in the raw buffer may no longer be valid for the new conditions.

A WTRU supporting multiple CSI compression modes (e.g., TSF, SF, another CSI feedback, and/or none) may determine and/or select the next compression mode as a function of configuration, channel conditions, current compression metric and/or target performance. The WTRU may determine the next compression mode when triggered to measure the configured metrics (e.g., SGCS).

The WTRU may select SF as the next compression mode, (e.g., when the WTRU speed exceeds a configured threshold).

When the WTRU is configured with a target performance, the WTRU may select the next compression mode as the one with higher compression rate compared to the current compression rate while still meeting the target performance.

In When the WTRU is configured with a compression rate, the WTRU may select the next compression mode as a function of the configured metric and/or the configured metric threshold(s) and/or the current compression mode.

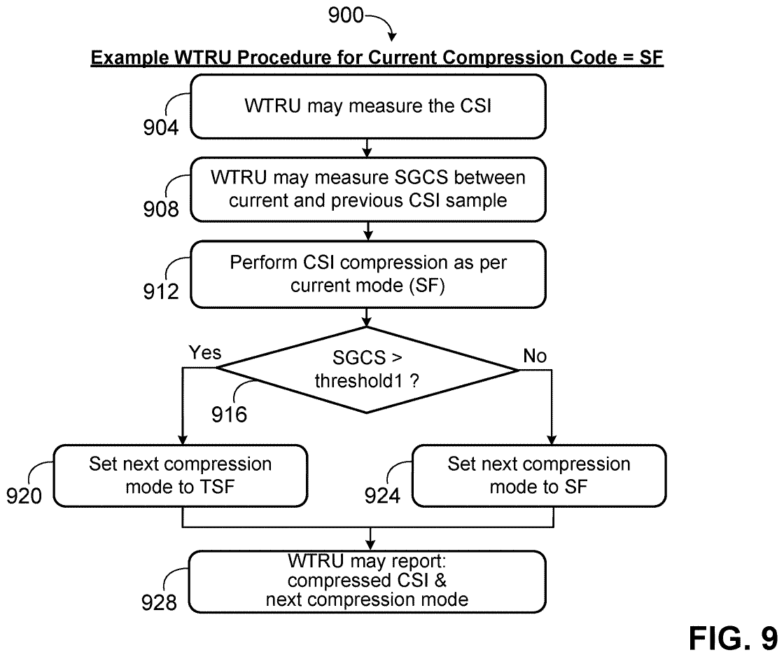

FIG. 9 depicts an example procedure 900 for determining the next compression mode when the current compression mode is SF. At 904, the WTRU may measure the CSI on the received CSI-RS. At 908, if triggered to measure the configured metrics (e.g., SGCS, temporal correlation, and/or NMSE, etc.) the WTRU may use the current and/or the previous CSI samples to measure the metrics (e.g., SGCS).

At 912, the WTRU may perform CSI compression using the current SF mode. At 916, the WTRU may compare the metric (e.g., SGCS) to the configured threshold (e.g., the first threshold). At 920, if the metric (e.g., SGCS) exceeds the first threshold, the WTRU may set the next compression mode to TSF. At 924, if the metric (e.g., SGCS) does not exceed the first threshold, the WTRU may otherwise set the next compression mode to SF. At 928, the WTRU may report the compressed CSI and/or the determined next compression mode to the gNB.

When the WTRU determines TSF as the next compression mode, the WTRU may switch the compression mode to TSF upon receiving a switch command from the gNB. The WTRU may make the switch to ensure that the gNB and/or the WTRU TSF buffers are in-sync.

In examples, the WTRU procedure for determining the next compression mode when the current compression mode is SF may also store and/or report the configured number of historical CSI in the raw buffer. Having more than one historical CSI stored in the raw buffer while in SF mode may improve the performance during the switch from SF to TSF compression by reducing the time needed to fill the history buffer. When the WTRU reports the next compression mode as TSF, the WTRU may additionally report the current number of samples in the raw buffer.

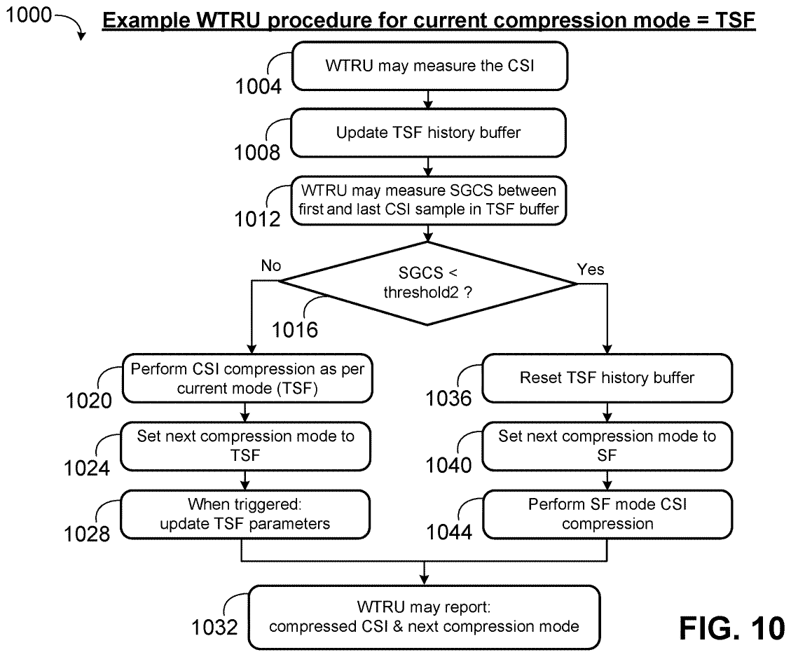

FIG. 10 depicts an example procedure 1000 for determining the next compression mode when the current compression mode is TSF. At 1004, the WTRU may measure the CSI on the received CSI-RS. At 1008, the WTRU may update the raw buffer (e.g., TSF history buffer). At 1012, if triggered to measure the configured metrics (e.g., SGCS, temporal correlation, and/or NMSE, etc.) the WTRU may use the first and/or last sample in the TSF buffer to measure the metrics (e.g., SGCS). At 1016, the WTRU may compare the metric (e.g., SGCS) to the configured threshold (e.g. the second threshold).

At 1020, when the current compression mode is TSF, the WTRU may perform TSF CSI compression. At 1024, if the metric (e.g., SGCS) is less than the second threshold, the WTRU may set the next compression mode to TSF. At 1028, the WTRU may also update the TSF parameters if triggered to determine updated TSF parameters.

At 1036, if the metric (e.g., SGCS exceeds the second threshold, the WTRU may set the next compression mode to SF. At 1040, then the next compression mode is determined as SF, the WTRU may reset the TSF history buffer (e.g., raw buffer), and/or perform SF CSI compression. At 1032, the WTRU may report the compressed CSI and/or the determined next compression mode to the gNB.

A WTRU configured for compression mode determination and/or selection may report the determined compression mode (e.g., the next compression mode) and/or the parameters associated with the next compression mode. The report may include the next compression mode. The report may include parameters of the determined next compression mode: for example, if the next compression mode is TSF, the report may include the max TSF buffer size, the current number of CSI samples in the TSF buffer, the input domain for the TSF history buffer (e.g., full channel matrix or eigenvectors), selected compression rate. The report may include the value of the configured metric for the current compression mode (e.g., measured SGCS between two consecutive CSI samples for SF compression, and/or measured SGCS between the first and/or the last sample in the TSF buffer for TSF compression).

The determined next compression mode and/or the associated parameters may be reported jointly with the compressed CSI, and/or may be reported in different messages. For example, the determined next compression mode and/or the associated parameters may be reported jointly with the compressed CSI when the WTRU is configured for periodic CSI reporting. In this case, the joint report may use the configured CSI report resources. The determined next compression mode and/or the associated parameters may be reported when the WTRU is configured for semi-persistent CSI reporting over PUSCH. The determined next compression mode and/or the associated parameters may be reported when the WTRU is configured for aperiodic CSI reporting. The WTRU may skip the determination and/or reporting of compression mode when the WTRU is configured with semi-persistent CSI over PUCCH.

A WTRU may determine and/or report the next compression mode (e.g., TSF, SF, and/or none) as a function of channel conditions, configured metrics thresholds, and/or current compression mode.

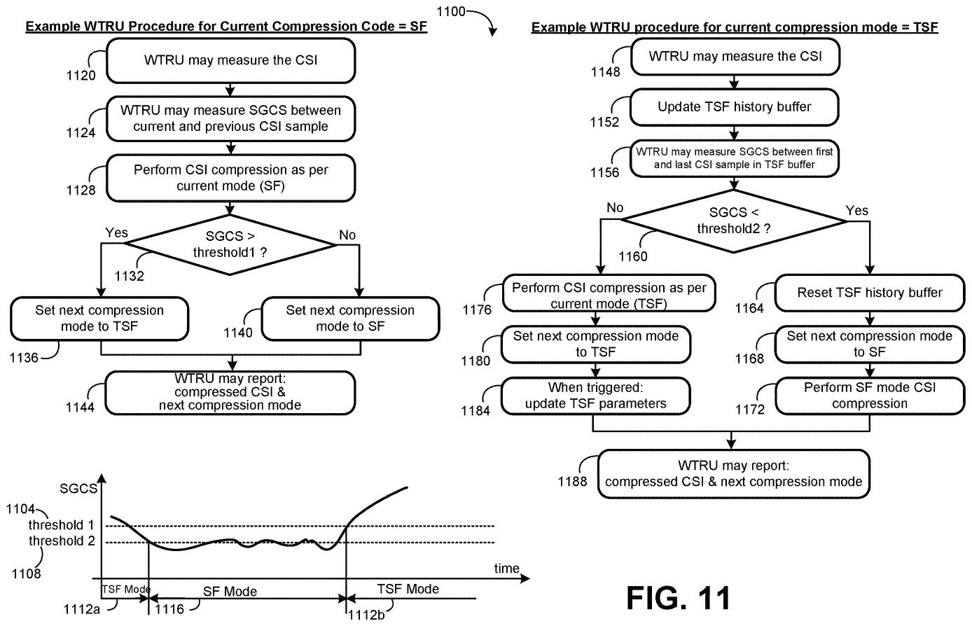

As shown in FIG. 11, the WTRU in a system 1100 using two-sided models for CSI compression may determine the next compression mode (e.g., TSF, SF, and/or none). The configuration may include: compression mode specific parameters, initial compression ratio, metrics for compression mode determination (e.g. SGCS), and/or a threshold (e.g., or set of thresholds) for compression mode determination (e.g., TSF SGCS).

The WTRU may measure the CSI. When triggered, the WTRU may perform measurements for compression mode determination (e.g., SGCS between the current and/or previous CSI sample, and/or SGCS between the first and/or last CSI samples in the TSF history buffer.)

The WTRU may determine the next compression mode as a function of channel conditions, configured metrics thresholds, and/or current compression mode. For example, the WTRU may determine the next compression mode as TSF 1112b if the current mode is SF 1116 and/or the measured performance metric exceeds a first configured threshold 1104. The WTRU may determine the next compression mode as SF 1116 if the current mode is TSF 1112a and/or the measured performance metric is below a second configured threshold 1108. The WTRU may determine the next compression mode as SF 1116 if the WTRU speed exceeds a configured threshold.

The WTRU may calculate the compressed CSI. The WTRU may report the next compression mode, the associated parameters, and/or the compressed CSI.

At 1120, to determine the next compression mode when current mode is SF, the WTRU may measure the CSI. At 1124, the WTRU may measure the SGCS between current and/or previous CSI samples. At 1128, the WTRU may perform CSI compression based on current mode (SF). At 1132, the WTRU may determine a condition that the measured SGCS exceeds a first threshold. At 1136, if the measured SGCS exceeds a first threshold, the WTRU may set the next compression mode to TSF. At 1140, if the measured SGCS is less than the first threshold, the WTRU may set the next compression mode to SF. At 1144, the WTRU may report the next compression mode and/or the compressed CSI.

At 1148, to determine the next compression mode when the current mode is TSF, the WTRU may measure the CSI. At 1152, the WTRU may update the TSF history buffer. At 1156, the WTRU may measure the SGCS between the first and/or last CSI sample in the TSF buffer. At 1160, the WTRU may determine that the measured SGCS exceeds a second threshold. At 1164, if the measured SGCS may be less than a second threshold, the WTRU may reset the TSF history buffer. At 1168, the WTRU may set the next compression mode to SF. At 1172, the WTRU may perform SF mode CSI compression.

At 1176, that the measured SGCS may exceed a second threshold and/or the WTRU may perform CSI compression as per the current compression mode (e.g., TSF). At 1180, the WTRU may set the next compression mode to TSF. At 1184, the WTRU may update the TSF parameters when triggered. At 1188, the WTRU may report the next compression mode and/or the compressed CSI.

A WTRU performing TSF domain CSI compression may determine and/or report (e.g., a set of) preferred hidden buffer states. The WTRU may determine a set of preferred hidden buffer states as a function of one or more metrics associated with the hidden buffer states and/or channel conditions (e.g., including identified blockage events).

The WTRU performing TSF domain compression may determine and/or report preferred hidden buffer states. For example, the configuration may include one or more of: a maximum hidden state buffer size, such as the maximum number of hidden states to store, wherein hidden state X denotes an intermediate/hidden representation of a sequence of X historical CSI samples (e.g., raw CSI and/or eigenvector); one or more TSF parameters (e.g., TSF buffer maximum size); preconfigured performance threshold (e.g., TSF SGCS); hidden states monitoring/observation periodicity (e.g., X ms); and/or activation for selecting/recommending the preferred hidden state.

The WTRU may determine a (e.g., a set of) preferred hidden state(s) to store in the hidden buffer based on the SGCS performance, an identified blockage event, the PDSCH performance, and/or an observation periodicity. The WTRU may update the performance information (e.g., SGCS) associated with each preferred hidden state. The WTRU may update (e.g., add, remove, and/or replace) the preferred hidden state based on WTRU's speed and/or a configured periodicity for a state to become obsolete.

The WTRU may determine (e.g., identify) which hidden state to revisit based on the measured correlation coefficient relative to the configured threshold. Additionally or alternatively, the WTRU may determine (e.g., identify) which hidden state to revisit based on the measured performance at each state.

The WTRU may calculate the compressed CSI based on the selected hidden state. The WTRU may report (e.g., to the network) an indication of the preferred hidden states and/or associated parameters (e.g., associated performance and/or state update message) to update the hidden state buffer. For example, the indication may include the selected hidden state to apply (e.g., selected state ID, performance, etc.). The WTRU may report the compressed CSI using the selected hidden state.

As described herein, when RNNs are used as examples, the techniques are not limited to just RNNs.

Rather, techniques may apply to any type of AI/ML model including, but not limited to: long short-term memory (LSTM), gated recurrent units (GRU), attention-based models (e.g., transformers), AE models (e.g., variational autoencoders and/or conditional variational autoencoders, etc.). The terms TSF hidden state and hidden state, may be used interchangeably herein.

Although the methods described herein apply the CSI compression use case as an example, the examples may not be limited to CSI compression. Rather, broadly consider the methods as they may apply for any use case. As described herein, the term hidden state may refer to intermediate representation of an input sequence(s). The input may be latent vector, CSI samples, eigenvectors, raw channels and/or any preprocessed versions thereof.

Representation herein may include one or more of a low or high dimensional representation, a compressed representation, encoded representation, non-linear transformation, a summary of previous input sequence(s), a belief about future sequence(s), a temporal dependency information, a correlation information, and/or extracted, aggregated, and/or selected feature information. Hidden state may also refer to internal memory state; for example, an internal state of an AI model that corresponds to information from the past sequence(s) and/or inference(s). Hidden state may also refer to a set of activations associated with one or more layers (e.g., a hidden layer) of the AI/ML model at specific time step during inference. Hidden state may correspond to state as in Markov decision process.

The hidden state may capture the relevant and/or important information from the previous input and/or representation thereof which may be useful for subsequent inference.

The output of an AI/ML model may be a function of input applied to the model and/or the hidden state of the model at the time of inference. The hidden state itself may be a function of previous input.

The hidden state may be initialized to a configured value (e.g., during initial inference and/or when a hidden state revisited based on one or more examples described herein).

The exact value of hidden state may be different for the model at the WTRU and/or the model at the NW. Hidden state at the WTRU side model may be associated with corresponding hidden state at the NW side model. Each side may have its own hidden state, but the hidden states may be implicitly and/or explicitly synchronized for proper operation (e.g., reconstruction of CSI at the decoder). Similarly, the WTRU may store its hidden states in WTRU's hidden state buffer. The gNB may store its hidden states in gNB's hidden state buffer.

Terms related to hidden states may be defined as follows: a stored hidden state(s) may refer to one or more of hidden state(s) saved in a hidden state buffer. A current hidden state may refer to the hidden state used for inference of current sequence and/or input. By default, the current hidden state may be based on the most recent inference. In some specific cases (e.g., upon hidden state retrieval), the current hidden state may be set to a specific hidden state from the hidden state buffer. An initial hidden state may refer to the hidden state which may be initialized to a preconfigured value (e.g., all zeros and/or random values with a preconfigured pattern and/or distribution or set to predefined value). A hidden state retrieval may refer to the setting of current hidden state to a previously stored hidden state from the hidden state buffer.

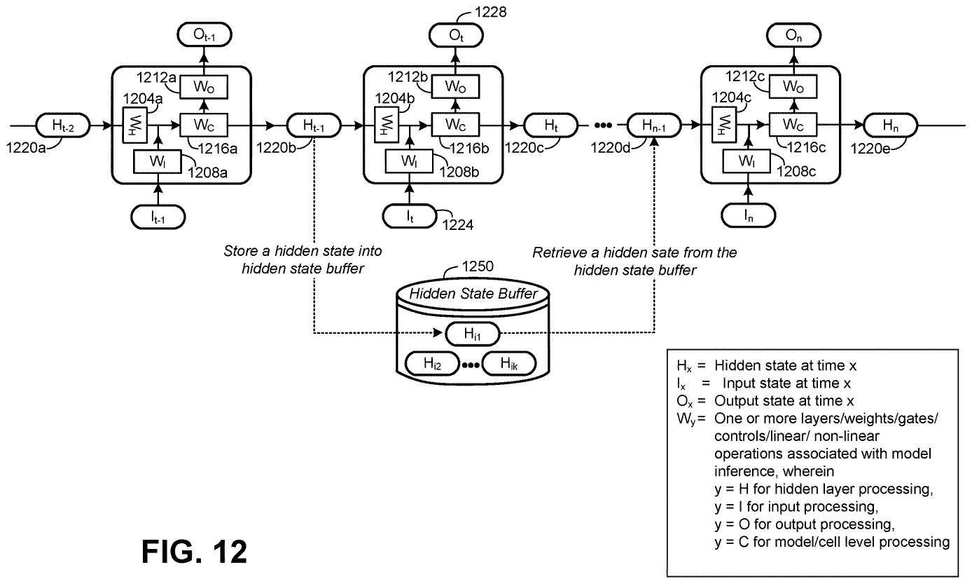

An example realization of the hidden state framework is depicted in FIG. 12. FIG. 12 shows inference at three instances: t−1, t, and n, wherein t−1 and t are consecutive time instances and n is at a future time. The AI/ML model may be generally expressed as tensors W_{H} 1204 a, b, c, W₁1208 a, b, c, W₀ 1212 a, b, c, Wₑ 1216 a, b, c and/or hidden state Hₓ 1220 a, b, c, d, e. Possibly the tensors may correspond to layers, weights, gates, controls, and/or non-linear functions (e.g., rectified linear unit (ReLU) and/or, sigmoid, etc.). Depending on the choices and/or design of these tensors, different types of AI/ML model types may apply. It should be noted that FIG. 12 may be an example realization. The techniques described herein may apply for any AI/ML model, architecture, hyperparameter, etc. As shown in the FIG. 12, at time t, the model may take as input tensor Iₜ 1224 and/or outputs a tensor Oₜ 1228 The output may be a function of input at time t and/or the hidden state at previous time step (e.g., Hₜ₋₁ 1220b).

At time t, the model may also generate a hidden state H, 1220c. For example, the hidden state Hₜ 1220c may store a representation of input at time t and/or representation of the inputs at previous time steps. Based on one or more techniques described herein, the WTRU may store a hidden state in a hidden state buffer 1250 based on the first set of conditions and/or retrieve a hidden state based on second set of conditions.

The WTRU may report capability elements associated with hidden state adaptation including explicit indication of maximum hidden state buffer size (e.g., in terms of number of bytes available for hidden state buffer and/or size of each hidden state etc.). In examples, the WTRU may indicate additional granularity in terms of hidden state buffer size per cell, scenario, and/or CSI configuration thereof e.g., bottleneck size, number of antennas, and/or rank, etc.

The WTRU may report capability elements associated with hidden state adaptation. These capability elements may further include implicit indication of maximum hidden state buffer size (e.g., maximum number of hidden states that can be stored in the hidden state buffer, etc.). In examples, the WTRU may indicate additional granularity in terms of hidden state buffer size per cell, scenario, and/or CSI configuration thereof (e.g., bottleneck size, number of antennas, and/or rank, etc.).

The WTRU may report capability elements associated with hidden state adaptation. These capability elements may further include latency of hidden state retrieval (in terms of milliseconds (ms), slots, subframes, and/or frames, etc.); quantization of hidden state before storage into hidden state buffer; preconfigured performance threshold (e.g., SGCS, NMSE, throughput, and/or PDSCH performance etc.); hidden state monitoring and/or observation periodicity (e.g., X ms); and/or configuration for selection and/or transmission of feedback for preferred hidden state and/or hidden state buffer management.

The WTRU may be configured with parameters for hidden state adaptation including one or more of the following: quantization of weights in hidden state, maximum number of hidden states in the hidden state buffer, minimum time between successive hidden state buffer update, minimum time between successive hidden state update, criteria for hidden state storage in hidden state buffer, criteria for hidden state retrieval, maximum number of past samples for hidden state update, and/or validity time associated with stored hidden state.

A WTRU may be configured with procedures for hidden state buffer management. One or more hidden state(s) may learn a representation of underlying channel condition and/or statistics, e.g., based on correlation between successive channel samples. This idea may be leveraged to identify, store, and/or later use the appropriate hidden state for optimal operation of AI/ML model.

The WTRU may add and/or remove hidden state to the hidden state buffer. The WTRU may replace a first hidden state in the hidden state buffer with a second hidden state. The WTRU reset the hidden state buffer. Herein, reset means removing all the hidden state(s) from the hidden state buffer.

The WTRU may divide hidden state buffer logically into sub-buffers, wherein each sub-buffer may associate with a serving cell, configuration, scenario, use case (e.g., CSI compression and/or beam prediction, etc.), a configuration specific use case (e.g., CSI configuration like bottleneck size, number of antennas, and/or rank, etc.).

The WTRU may apply more techniques herein at the hidden buffer granularity and/or sub-buffer granularity.

The WTRU may store a hidden state to hidden state buffer when the hidden state satisfies one or more of the following conditions, including a minimum number of time instances of successive RNN operation. In examples, for a hidden state to contain any viable information deemed worth storing and/or retrieving, the RNN in its current state may have operated for at least S1 time instances. Herein, time instances means that the recursive RNN operation has completed for S1 repetitions. If the operation of the RNN has been interrupted and/or reset within less than S1 time instances, the RNN buffer may not be suited for storage in the buffer.

The WTRU may store a hidden state to hidden state buffer when the hidden state satisfies performance metric and/or threshold. The WTRU may store a hidden state in hidden state buffer when the performance of the hidden state meets a preconfigured criteria. To ensure that a newly added hidden state and/or replacing of an existing state meets a minimum performance level, the WTRU may evaluate one or more performance criteria. These performance criteria may include: system performance metrics like PDSCH performance, algorithmic spectral efficiency, bit error rate, and/or prediction performance measurement using normalized mean square error, cosine similarity, and/or an associated performance threshold.

The WTRU may store a hidden state to hidden state buffer when the hidden state satisfies relative performance of a new hidden state. The WTRU may maintain at most top N performing hidden states in the hidden state buffer. The value of N may be preconfigured. The value of N may be a function of WTRU capability. For example, when the performance of a new hidden state exceeds any of the top N hidden states in the hidden state buffer, the WTRU may store the new hidden state in the hidden state buffer.

The WTRU may store a hidden state to hidden state buffer applicable conditions change. For example, the WTRU may add a hidden state to the hidden state buffer when the WTRU detects a change in applicable condition and/or a corresponding hidden state does not exist in the hidden state buffer. The applicable condition may include scenario (e.g., Doppler, and/or WTRU speed, etc.), configuration (antenna configuration, and/or bandwidth etc.), deployment, and/or applicable cell, site, area, zone, and/or WTRU measurement (e.g., rank and/or SNR).

The WTRU may store a hidden state to hidden state buffer upon detection of beam failure and/or radio link failure. For example, the WTRU may trigger hidden buffer update upon identification of blockage event.

The WTRU may store a hidden state to hidden state buffer when the correlation between current channel measurement and/or the channel statistic associated with the hidden state exceeds a preconfigured threshold.

In examples, the WTRU may monitor the criteria associated with hidden state for a preconfigured observation periodicity. The WTRU may be configured with conditions to ensure that the WTRU may not store more than one hidden state associated with the same applicable condition. To avoid duplication, the WTRU may maintain the best performing hidden state for a specific applicable condition. The WTRU may maintain a look back buffer. The WTRU and/or gNB may maintain a S2 length buffer of past channel estimates and/or past hidden states in memory. Herein, S2 may be the look back period and S2>S1. Once the WTRU has determined that a hidden state has to be stored, the WTRU may choose the current state and/or any of the states from the past S2 instances to store in the buffer.

A WTRU may be configured for reporting, feedback, and/or signaling for hidden state buffer updates. In examples, each hidden state may be associated with a context. Each hidden state and/or its context may be associated with a logical identity. The logical identity may uniquely identify the hidden state. The logical identity may be unique among all the hidden states within the WTRU. The logical identity may be derived based on a time component (e.g., slot number, subframe number, and/or frame number, etc.).

The context may include metrics related to inference performance associated with the hidden state. The performance metric may include SGCS, average SGCS, NMSE, average NMSE, BLER threshold, and/or throughput, etc. The context may include the input to the AI/ML model (e.g., raw channel matrix, eigenvector, and/or any preprocessed input thereof). The context may include a statistic associated with the input sample and/or sequence that was used for generation of the hidden state.

Context associated with hidden state may include relevant parameters for buffer management. To explicitly and/or uniquely define a hidden state and/or ensure effective detection and/or retrieval when the need arises, just storing the hidden states independently may be insufficient. Additional parameters may enhance the usability of the hidden states.

Associated channel state information regarding representation of the channel from the current time instant (e.g., when the hidden state was selected for buffering) and/or the few past time instants may be stored. The channel state representation may be in the full channel form, the eigenvector form, and/or in any other form that provides some direct and/or derived information about the channel state.

Performance indicators may include the performance of the ML model for the TSF compression and/or prediction in terms of NMSE, cosine similarity, and/or through any other metric. Additionally or alternatively, the performance of the overall communication setup as the PDSCH performance and/or the bit error rate or through other metrics may also be stored with the hidden state.

The WTRU may associate each hidden state in the hidden state buffer with a logical identity. Such logical identity may be assigned when the WTRU adds the hidden state to the hidden state buffer. Such logical identity may be assigned in the signaling that configures the WTRU to store the hidden state in the hidden buffer. Such logical identity may be a function of time instance that generates the hidden state (e.g., during inference of a sample at time t). Such time instance may be associated with slot, subframe, and/or frame number.

The WTRU may trigger hidden state buffer update based on periodic, aperiodic, semi-persistent and/or based on preconfigured condition. The WTRU may transmit feedback to the gNB indicating what hidden state(s) to store in the hidden state buffer. The WTRU may send such indication when the WTRU updates its own local hidden state buffer. The WTRU may transmit the feedback when one or more conditions for hidden state buffer updates exist. The WTRU may indicate the hidden state based on logical identity associated with the hidden state. The WTRU may indicate a relative time offset to the hidden state. The relative time offset may indicate the time of inference during which the hidden state was generated. The relative time offset may indicate the slot, subframe, frame, and/or at which the CSI report was transmitted, wherein the CSI report may be generated by the hidden state. The relative time offset may indicate the slot, subframe, frame and/or where the CSI-RS associated with the input sequence which generated the hidden state.

The WTRU may report the identity of hidden state and/or the context associated with the hidden state to the gNB.

The WTRU may transmit the feedback as part of the CSI report. For example, the CSI report may comprise two parts. The first part may include hidden state buffer update feedback. The second part may include the compressed CSI feedback using the RNN encoder model. The WTRU may transmit the hidden state buffer update feedback via UCI and/or in a PUSCH resource and/or in MAC CE. The WTRU may transmit the TSF feedback in a PUSCH resource while the CSI feedback via UCI.

A WTRU may be preconfigured with one or more rules to determine the hidden state to use and/or apply for inference. The WTRU may use the hidden state based on the most recent inference (e.g., t−1) as the hidden state for inference of current sequence/input at time t.

A WTRU may be configured with triggers for initializing and/or resetting hidden state to a preconfigured value. The WTRU may set (e.g., initialize and/or reset) the hidden state to a preconfigured value when one or more conditions are satisfied. The WTRU may set the hidden state to a preconfigured value when the AI/ML model is activated for inference. The AI/ML model may be in a deactivated state before activation. The WTRU may set the hidden state to a preconfigured value when the WTRU performs RRC reconfiguration. The WTRU may perform RRC reconfiguration with sync. The WTRU may set the hidden state to preconfigured value when the WTRU performs re-establishment. The WTRU may set the hidden state to preconfigured value when the WTRU transitions from IDLE to CONNECTED state.

The WTRU may set a hidden state to a retrieved hidden state from a hidden state buffer when one or more trigger conditions are satisfied. The applicable condition may include scenario (e.g., Doppler and/or WTRU speed etc.), configuration (e.g., antenna configuration, bandwidth etc.), deployment, applicable cell, site, area, and/or zone, and/or WTRU measurement (e.g., rank and/or SNR), etc. The WTRU may trigger hidden state retrieval when the applicable conditions change and/or there exists a hidden state whose context and/or applicable condition matches with the current applicable condition.

Applicable conditions may also occur upon detection of beam failure and/or radio link failure. For example, the WTRU may trigger hidden state update upon identification of a blockage event. Applicable conditions may also occur when the correlation between current channel measurement and/or the channel statistic associated with the hidden state exceeds a preconfigured threshold.

The WTRU may trigger the retrieval based on one or multiple performance metrics. For example, the performance may include poor PDSCH performance for at least R1 slots or transmission time intervals (TTIs), (e.g., the number of NACKs within R1 TTIs exceeds a preconfigured threshold), where R1 may be configured by the network. The performance metrics may include large changes in the channel correlation, changes in channel derived metrics like Doppler, delay spread, etc.

Based on the performance metrics, the WTRU may initiate the retrieval process. In the retrieval process, the WTRU may self identify the optimal hidden state to retrieve an explicit state. The gNB may define the explicit state to be retrieved. For self-determination, the WTRU may employ methods to check the similarity between the current channel state and the buffered channel states, corresponding to each of the hidden states. The similarity may be evaluated in terms of channel state cross correlation, evaluating the cosine similarity, the normalized errors, and/or through any other metric. Amongst past states where correlation, SGCS, and/or other metrics indicate a similarity above a threshold level, the most similar one may be selected. The current RNN hidden state may be flushed and/or replaced with the selected state.

When reporting, providing feedback, and/or signaling for a hidden state update, the WTRU may configure the hidden state to all zeros. The WTRU may set the hidden state to identity matrix. The WTRU may set the hidden state to a random value with a preconfigured distribution. The WTRU may set the hidden state to a random value based on a pseudorandom sequence generator. The pseudorandom sequence generator parameters may be preconfigured. The pseudorandom sequence generator may be initialized with a seed value. The seed value may be a function of slot, subframe, and/or frame number. The hidden state may be set to a preconfigured value wherein the value may be a function of training outcome and/or dataset. The training may be offline or online. The hidden state may be set to a predefined value. The predefined value may be a function of scenario, use case, configuration, deployment, and/or cell and/or area, etc.

The WTRU may set the hidden state to a value explicitly signaled from the gNB. Such value may be signaled in a RRC configuration. The WTRU may be preconfigured to a plurality of hidden state value and/or each hidden state value may be associated with a logical identity. The WTRU may set the hidden state to a value based on the logical identity received from the gNB. Such logical identity may be signaled in RRC message, MAC CE, and/or in a DCI.

The WTRU may set the hidden state based on the hidden state retrieved from the hidden state buffer. The WTRU may associate each hidden state in the hidden state buffer with a logical identity. Such a logical identity may be assigned when the WTRU adds the hidden state to the hidden state buffer. Such a logical identity may be assigned in the signaling that configures the WTRU to store the hidden state in the hidden buffer. Such a logical identity may be a function of time instance that generates the hidden state (e.g., during inference of a sample at time t). Such time instance may be associated with slot, subframe, and/or frame number.

Upon setting the hidden state value based on one or more examples herein, the WTRU may use that hidden state for subsequent inference. The WTRU may use the hidden state for the generation of the next output. The WTRU may use the hidden state to generate CSI report or parts thereof.

Hidden state storage may be synched at WTRU and/or gNB. The WTRU may send a request to gNB to update its buffer with a new hidden state (e.g., when determining that a new hidden state needs to be added to the buffer and/or an existing hidden state needs to be replaced). The WTRU may additionally specify the time stamp of the exact time instant at which the hidden state should be buffered.

The WTRU may trigger hidden state update based on periodic, aperiodic, semi-persistent and/or based on preconfigured condition. The WTRU may transmit the feedback as part of the CSI report. The CSI report may comprise two parts. The first part may include hidden state buffer update feedback. The second part may include the compressed CSI feedback using the RNN encoder model. The WTRU may transmit the hidden state update feedback via UCI and/or in a PUSCH resource and/or in MAC CE. The WTRU may transmit the hidden state buffer feedback in a PUSCH resource while the hidden state updates feedback via UCI.

During the hidden state retrieval, the retrieval may be carried out based on the channel state and/or hidden state at the current time instant, in which case the hidden state may be directly utilized for RNN processing. Additionally or alternatively, the WTRU and/or gNB may identify a past time instant at which the hidden state retrieval and/or plugin becomes more beneficial than using the current hidden state (e.g., that results in lower reconstruction error). The WTRU and/or gNB may determine a past channel state which has a high degree of similarity (e.g., high SGCS) with the current channel state, where the past channel states and/or the corresponding hidden states may be available in the channel/hidden state buffer. The WTRU may then use the determined past channel state to determine the past hidden state for retrieval.

To enable this processing, the WTRU and/or gNB may maintain R2 past channel estimates and/or hidden states in memory, where R2 may be the maximum allowable look back period. If any of the past [t-R2 to t−1] channels has a greater similarity with the current channel (e.g., SGCS value exceeding a configured threshold), then the RNN may be restored with the selected hidden state and/or past set of channel states corresponding to the index t-R3 of the channel state that maximizes the SGCS. The value of R3 may be in the range of 1 to R2, or it may be zero if the SGCS values corresponding to all past [t-R2 to t−1] channels are below the configured threshold Any of the past channels (starting from index t-R3) leading up to the current time instant may be again compressed with the newly selected hidden state. Thus, starting from the selected instant (e.g., t-R3,) the set of channels in the range (e.g., [t-R3 to t−1]) may be recompressed.

The compressed representation associated with the past R3 channels may be re-sent to the gNB. The gNB may restore the same hidden state and/or run the RNN with the restored state and/or the past R3 channels to reach the current channel. If R3=0, may be the equivalent to having no additional transmissions of past channels. Having R3=0 may require just the reset of hidden state at both WTRU and/or gNB.

A WTRU performing TSF domain compression may determine and/or report preferred hidden buffer states. The configuration may include: maximum hidden buffer size (e.g., the maximum number of hidden states to store, wherein hidden state X denotes an intermediate and/or hidden representation of a sequence of X historical CSI samples (e.g., raw CSI or eigenvector)); TSF parameters (e.g., TSF buffer maximum size); preconfigured performance threshold (e.g., TSF and/or SGCS); hidden states monitoring and/or observation periodicity (e.g., X ms); activation for selecting and/or recommending the preferred hidden state.

The WTRU may determine a set of preferred hidden state(s) to store in the hidden state buffer based on, SGCS performance, identified blockage event, PDSCH performance, and/or observation periodicity. The WTRU may update performance information (e.g., SGCS) associated with each preferred hidden state. The WTRU may determine an update (e.g., add, remove, and/or replace) to a preferred hidden state (e.g., based on WTRU speed or a configured periodicity for a hidden state to become obsolete).

The WTRU may determine which hidden state to revisit and/or apply (e.g., based on the measured correlation coefficient relative to the configured threshold and/or based on the measured performance at each state).

The WTRU may calculate the compressed CSI based on the selected hidden state. The WTRU may report an indication for the preferred hidden states and associated parameters (e.g., associated performance, state update message, and/or hidden state ID) to update the hidden state buffer. The WTRU may report an indication that includes the selected hidden state to apply (e.g., selected state ID, and/or performance, etc.) The WTRU may report the compressed CSI using the selected hidden state.

A WTRU may detect and/or mitigate of out-of-sync events (e.g., misalignment between WTRU and/or NW TSF buffers) by WTRUs performing TSF domain CSI compression. The WTRU performing TSF domain compression may detect and/or report out-of-sync events. For example, the configuration may include: network performance indicators (e.g., an SGCS measured at gNB between first and last samples in the gNB buffer); an out-of-sync performance threshold; an out-of-sync periodicity (e.g., every X ms WTRU takes an action); and/or an indication for synchronization monitoring.

The WTRU may be triggered to perform measurements, which may be used for out-of-sync detection and mitigation. The WTRU may determine that an out-of-sync event occurred (e.g., based on comparing the measured SGCS at the WTRU) and/or the indicated SGCS from the network, (e.g., when the mismatch exceeds the configured performance threshold).

Upon detecting an out-of-sync event, the WTRU may switch to/recommend another compression mode (e.g., SF or another CSI feedback); and/or partially flush the hidden buffer (e.g., by keeping the newest N samples, where N is less than or equal to the max buffer size).

Upon detecting an out-of-sync event, the WTRU may indicate detection of an out-of-sync event; the WTRU's behavior for out-of-sync mitigation (e.g., compression mode switching, buffer flush of N samples, etc.); and/or a performance metric for out-of-sync monitoring (e.g., SGCS between first and/or last samples in the WTRU buffer).

A WTRU capable of performing TSF domain CSI compression may detect, mitigate, and/or report out-of-sync detection CSI feedback reporting, via one or more of RRC, MAC CE, and/or DCI.

The configuration for out-of-sync detection and/or mitigation may include NW SGCS performance, wherein the WTRU may receive NW SGCS measured at gNB side between first and/or last samples in the gNB buffer.

The configuration for out-of-sync detection and/or mitigation may include an out-of-sync performance threshold. The WTRU may be configured with the out-of-sync performance threshold. For example, if SGCG is configured as the metric for compression performance evaluation, then the threshold may represent thresholds for SGCS difference between WTRU and/or NW SGCS.

The configuration for out-of-sync detection and/or mitigation may include out-of-sync periodicity, wherein the WTRU may be configured with an out-of-sync periodicity which denotes the periodicity of NW SGCS Performance received by the WTRU. The WTRU may perform out-of-sync detection at every time instant determined based on this configuration.

The configuration for out-of-sync detection and/or mitigation may include an indication for synchronization monitoring. The WTRU may receive an indication for synchronization monitoring to decide whether to perform out-of-sync detection.

The configuration for out-of-sync detection and/or mitigation may include an indication for buffer counter reporting. The WTRU may receive an indication for reporting the buffer counter together with CSI to mitigate out-of-sync events.

A WTRU may detect out-of-sync events via any one or more of the following methods, including reception of an explicit indication from the network. The WTRU may receive an implicit indication of an out-of-sync event from the NW. The indication may be accompanied by a resulting action (e.g., request for WTRU to switch back to SF compression mode and/or another CSI feedback). The WTRU may receive an indication of poor performance of the encoder. The WTRU may revert back to SF mode and/or to another CSI framework.

The configuration for detection of out-of-sync events may include reception of an implicit indication from the network. The WTRU may receive from the NW implicit indications of out-of-sync events. For example, a request to switch to SF compression mode or a request to flush or partially flush the buffer. Reception of the number of buffer samples N mid operation may indicate to the WTRU that resynchronization is needed. Reception of an index Nᵢ^{NW} corresponding to the buffer sample being used at that time instant at the decoder at the NW may indicate to the WTRU to resynchronize to the corresponding Nᵢ^{WTRU} at the WTRU.

The configuration for detection of out-of-sync events may include comparing the measured SGCS at the WTRU and/or the indicated SGCS from the NW. Following the reception of SGCS from the NW, the WTRU may compare the value against the measured SGCS at the WTRU. If the difference is larger than a threshold, the WTRU may determine that an out-of-sync event has happened. The WTRU may request from the NW the value of the SGCS measured at the NW. For example, the WTRU may send the request from the NW following failure of reception of the indicated SGCS from the NW. The WTRU may send the request to the NW if other conditions are met, (e.g., the WTRU may receive from the NW CSI-RS and use the CSI-RS to compute CSI parameters). If the CSI parameters are poor (e.g., CQI below a threshold), the WTRU may request from the NW the measured SGCS at the decoder to determine whether an out-of-sync event has occurred.

The configuration for detection of out-of-sync events may include computing and/or comparing other measurements made at the WTRU against measurements made at the NW and indicated to the WTRU. These measurements may be channel measurements (e.g., Doppler, SINR, channel coherence time, and/or channel coherence bandwidth, etc.). Similarly, the WTRU may make the comparison of reception of the measurements from the NW. In examples, the WTRU may request for the measurements from the NW.

The configuration for detection of out-of-sync events may include computing and comparing measurements made at the WTRU against statistical data. In examples, the WTRU may be preconfigured with some statistical data (e.g., average and/or mean SGCS). The WTRU may measure and/or compute the SGCS and compare it against the statistical data. If the difference is less than a threshold, the WTRU may determine that an out-of-sync event has occurred. In one example, the WTRU may collect and/or compute the statistical data (e.g., compute average and/or mean SGCS based on past number of instantaneous SGCS values).

The configuration for detection of out-of-sync events may include performance monitoring of the encoder. The WTRU may conduct performance monitoring of the encoder as one of the life cycle management (LCM) stages by computing the correlation and/or difference between the first and last value in the WTRU buffer, and/or by using general and/or intermediate key performance indicators (KPIs) (e.g., throughput, SGCS, and/or BLER, etc.). On detecting poor performance (e.g., according to a performance monitoring configuration received from the NW), the WTRU may determine that an out-of-sync event has occurred. The performance monitoring of the encoder may be detected via measurement of model hyper parameters (e.g., latency for the AI/ML model to produce an output). If the latency of the CSI encoder at the WTRU produces an output larger than a threshold, an out-of-sync event may be likelier to occur.

The configuration for detection of out-of-sync events may include configuration to detect out-of-sync events at WTRU for TSF mode compression may be a function of buffer size and/or buffer size difference between encoder at WTRU and decoder at NW. If the buffer size is larger than a threshold (resulting in large exploitation of the correlation properties of the channel), the WTRU may detect out-of-sync events more often via any one or more of the aforementioned methods. If the buffer size at the encoder matches (e.g., exactly matches) the buffer size at the decoder, the WTRU may detect out-of-sync events less often versus if there is a difference in the two buffer sizes.

Following the detection of an out-of-sync event, the WTRU may send a request for resources to the NW (e.g., via SR/BSR and/or any other MAC CE). The WTRU may use any available configured grant (CG) PUSCH occasion to indicate one or more of the following parameters to the network: occurrence of out-of-sync event (e.g., binary indication and/or flag that event occurred); time stamp of event; WTRU buffer index at which out-of-sync event occurred; request to flush or partially flush the buffer at the decoder's request to restart the buffer at the decoder (which may be accompanied by a timestamp at which the WTRU expects to restart the buffer at the WTRU side to achieve encoder-decoder synchronization); request to use a buffer of smaller size (to decrease the chances of out-of-sync events); request to switch to SF compression mode; and/or request to switch back to another CSI operation.

The WTRU may correct the out-of-sync event following its detection. In such a case, the WTRU may not send any indication to the network. The WTRU may receive periodic indications of the relevant buffer index being used at the decoder from the NW. The WTRU may compare the index with the corresponding index used at the encoder. In case of mismatch, the WTRU may adjust the buffer sample at the encoder. The WTRU may correct the out-of-sync event and/or still send an indication to the network (e.g., for bookkeeping purposes).

The WTRU may mitigate the out-of-sync events via buffer size matching. The buffer sizes at the encoder (e.g., WTRU) and decoder (e.g., NW) may match to mitigate out-of-sync events. If the buffer size is configurable, the WTRU may receive an indication of the buffer size to use for the corresponding decoder. The WTRU may be preconfigured with a few options of usable buffer sizes. At the start of a session (e.g., during RRC (re)configuration), the WTRU may receive an indication from the NW of the buffer size to use. Matching between the buffer size at encoder and/or decoder may signify the same number of buffer samples N such that Nᵢ^{WTRU}=Nᵢ^{NW}. In examples, Nᵢ^{NW} may be an integer multiple of Nᵢ^{WTRU}. The WTRU may perform synchronization checks with higher periodicity if there is a mismatch between the buffer sizes.

The configuration to mitigate the out-of-sync events may include encoder selection if WTRU has multiple encoders. The WTRU may select the encoder with buffer size matching the buffer size at the decoder. The WTRU may select the encoder with the least out-of-sync historical events recorded.

The configuration to mitigate the out-of-sync events may include checks and/or corresponding reporting. The WTRU may perform checks (e.g., periodic and/or spot checks). The WTRU may periodically check and/or report the index of the sample in the WTRU buffer used at the encoder.

The configuration to mitigate the out-of-sync events may include a request transmission to network. The WTRU may request for the index of the sample in the NW buffer used at the decoder and/or compare it against the index used at the encoder.

The configuration to mitigate the out-of-sync events may include periodic transmission of encoder ID (e.g., if the WTRU has multiple encoders).

The configuration to mitigate the out-of-sync events may include reducing the size of the buffer. The WTRU may measure a large mismatch (beyond the acceptable threshold) between the first and/or last samples in the WTRU buffer. Reducing the buffer size resulting in the first and/or last samples being closer to each other in time may result in higher correlation between the two samples. The WTRU may reduce the buffer size to improve the correlation and/or still use TSF while maintaining the reconstruction performance.

The configuration to mitigate the out-of-sync events may include a switch indication to network (e.g., following a switch to a different encoder and/or following a change in buffer size).

Detection and/or mitigation of out-of-sync events at the network may be based on measurements at the network. The network may measure general KPIs (e.g., throughput) and/or based on a drop in measurement, may determine that an out-of-sync event has happened.

Detection of out-of-sync events at the network may be based on measurements at the WTRU. The WTRU may perform measurements (e.g., SGCS) periodically, semi-periodically, and/or on request from the NW. The WTRU may report the measurements to the NW. The content of reporting from the WTRU to the NW may consist of one or more of the following: all measurements of SGCS; measurements of SGCS above and/or below a threshold; and/or measurements of SGCS with respect to indicated SGCS from NW. The WTRU may receive an indicated SGCS from the NW. The WTRU may report the measured SGCS at the WTRU if the difference between the WTRU measurement and/or the NW indicated value is above a threshold. In this case, the WTRU may report the measured SGCS and/or the computed differential SGCS.

The content of reporting may include measurements of SGCS if and/or when other conditions are fulfilled.

The WTRU may be configured to report the SGCS measurements if the WTRU computes other measurement values below a certain threshold. The WTRU may report SGCS when WTRU measures CQI below a threshold. The WTRU may report the SGCS measurements if the WTRU computes differential measurements larger than a threshold (e.g., differential measurement between one sample and/or the next for L1-RSRP>a threshold, and/or differential CQI value from one sample to the next greater than a threshold, etc.)

The periodicity of reporting of measurements from the WTRU to the NW may be a function of the SGCS value. If the measured SGCS value at the WTRU is below a threshold, the WTRU report the measurements to the NW at a higher periodicity (in anticipation of an out-of-sync event).

The content of reporting from the WTRU to the NW may be a function of the SGCS value. If the measured SGCS value at the WTRU is below a threshold, the WTRU may report all the measurements to the NW (in anticipation of an out-of-sync event), versus every other measurement if the measured SGCS value at the WTRU is above aforementioned threshold.

The content and/or periodicity of measurements reporting from the WTRU to the NW may be a function of the resources available at the WTRU (via configured grant and/or dynamic grant). The WTRU may consider the number of unused PUSCH resources in every configured grant (CG) occasion and adjust the periodicity of reporting measurements to the NW accordingly.

If measurements reported by the WTRU are above or below thresholds, the NW may determine that an out-of-sync event has occurred. In response, the WTRU may receive from the NW an explicit indication that an out-of-sync event has happened. The WTRU may receive from the NW the resulting action to perform (e.g., switch to another compression mode and/or to another CSI feedback).

The NW may mitigate out-of-sync events, including but not limited to sending configuration to WTRU to detect out-of-sync events; sending resources to WTRU so that WTRU can report the out-of-sync events to the network; sending measurements of the latest SGCS used at the network; sending measurements of the SGCS used at the network along with the corresponding timestamps.

The NW may mitigate out-of-sync events, including but not limited to sending of indices corresponding to measurements to the WTRU. The network may transmit indices corresponding to the TSF buffer value used at the NW side-decoder to the WTRU. The WTRU may receive the indices periodically and/or compare against the index of the TSF buffer at the WTRU. The WTRU may receive the indices in response to a request sent to the NW for the indices.

The NW may mitigate out-of-sync events, including but not limited to sending a request and/or indication to the WTRU to change buffer size, (e.g., to a smaller value to mitigate the probability of out-of-sync events); sending a request/indication to the WTRU to switch to an encoder with a TSF buffer size matching the buffer size at the network to minimize the probability of out-of-sync events; sending a request to switch to another encoder with less out-of-sync occurrences, (e.g., based on number of historical occurrences of out-of-sync events); and/or switching to a different decoder at the NW side.

A WTRU capable of performing TSF domain CSI compression and/or configured for out-of-sync detection may report parameters related to out-of-sync detection. The report may include the occurrence of an out-of-sync event. This field in the report may be one or more bits to represent an out-of-sync-event.

The report may include WTRU behavior for out-of-sync mitigation. This field in the report may represent the method used in the WTRU to mitigate the out-of-sync event in case of the detection of an out-of-sync event. The field may represent an index for the mitigation method such as compression mode switching, partial, and/or full buffer flush of N samples, etc.

The report may include performance metric for out-of-sync monitoring. The WTRU may report the performance metric used to detect the out-of-sync event such as an index to represent SGCS between first and/or last samples in the WTRU buffer, SGCS between the first and/or another configured sample in the WTRU buffer, etc.

The report may include buffer counter, wherein the WTRU may report a buffer counter together with CSI to mitigate out-of-sync events.

The reporting of the out-of-sync detection may be reported jointly with the compressed CSI and/or in different messages. The buffer counter may be reported with compressed CSI.

The reporting of the parameters of the out-of-sync detection may be configured for periodic, semi-persistent, and/or aperiodic reporting, for example over PUCCH and/or PUSCH.

A WTRU performing TSF domain compression may detect and/or report out-of-sync events and/or mitigate their impacts. The WTRU performing TSF domain compression, receives configuration to detect and report out-of-synch events. The configuration may include NW performance indicator (e.g., SGCS measured at gNB side between first and/or last samples in the gNB buffer); out-of-sync performance threshold; out-of-sync periodicity (e.g., every X ms WTRU takes an action); and/or indication for synchronization monitoring.

The WTRU configured to detect and/or report out-of-sync events and/or mitigate their impacts may be triggered to perform measurements for out-of-sync detection and/or mitigation.

The WTRU configured to detect and/or report out-of-sync events and/or mitigate their impacts may determine that an out-of-sync event occurred. The WTRU may base this determination on comparing the measured SGCS at the WTRU and/or the indicated SGCS from the NW, (e.g., when the mismatch exceeds the configured performance threshold).

Upon detecting an out-of-sync event, the WTRU may take one or more of the following actions: switch to and/or recommend another compression mode (e.g., SF and/or another CSI feedback); partial flush of the hidden buffer (e.g., by keeping the newest N samples, where N is less than or equal to the max buffer size).

The WTRU may indicate the occurrence of an out-of-sync event; WTRU behavior for out-of-sync mitigation (e.g., compression mode switching, and/or buffer flush of N samples, etc.); performance metric for out-of-sync monitoring (e.g., SGCS between first and/or last samples in the WTRU buffer.

What is claimed is:

1.-20. (canceled)

21. A method performed by a wireless transmit receive unit (WTRU), the method comprising:
receiving configuration information associated with temporal-spatial-frequency (TSF) compression;
measuring channel state information (CSI);
determining TSF parameters based on the configuration information and the measured CSI;
calculating a compressed CSI based on the measured CSI and the determined TSF parameters; and
sending the determined TSF parameters and the compressed CSI in a CSI measurement report.

22. The method of claim 21, wherein the configuration information comprises an indication of one or more of: a maximum TSF buffer size, an initial compression ratio, or a metric threshold.

23. The method of claim 21, wherein the TSF parameters comprise one or more of: a TSF buffer size, a TSF buffer performance indicator, a TSF buffer state, a compression rate, or a CSI input domain.

24. The method of claim 21, wherein the TSF parameters are determined based on one or more of: a measured correlation metric, a configured threshold, a measure of WTRU speed, or a measure of physical downlink shared channel (PDSCH) performance.

25. The method of claim 24, wherein the metric threshold comprises a measurement of a squared generalized cosine similarity (SGCS) between consecutive samples in the TSF buffer as compared to a TSF SGCS threshold.

26. The method of claim 24, wherein the metric threshold comprises a measurement of a SGCS between first and last samples in the TSF buffer as compared to a TSF SGCS threshold.

27. The method of claim 24, wherein the measure of WTRU speed is based on one or more of: an estimated Doppler, a feedback delay, or a CSI processing time.

28. The method of claim 24, wherein the measure of PDSCH performance is based on one or more of: a measured block error rate (BLER) or a measured number of consecutive acknowledgments or negative acknowledgments (ACK/NACK).

29. The method of claim 21, further comprising:
storing the measured CSI in a TSF buffer.

30. The method of claim 29, wherein the TSF buffer contains at least one of: one or more eigenvector samples, or one or more full CSI samples.

31. A wireless transmit receive unit (WTRU) comprising:
a processor configured to:
receive configuration information associated with temporal-spatial-frequency (TSF) compression;
measure channel state information (CSI);
determine TSF parameters based on the configuration information and the measured CSI;
calculate a compressed CSI based on the measured CSI and the determined TSF parameters; and
send the determined TSF parameters and the compressed CSI in a CSI measurement report.

32. The WTRU of claim 31, wherein the configuration information comprises an indication of one or more of: a maximum TSF buffer size, an initial compression ratio, or a metric threshold.

33. The WTRU of claim 31, wherein the TSF parameters comprise one or more of: a TSF buffer size, a TSF buffer performance indicator, a TSF buffer state, a compression rate, or a CSI input domain.

34. The WTRU of claim 31, wherein the TSF parameters are determined based on one or more of: a measured correlation metric, a configured threshold, a measure of WTRU speed, or a measure of physical downlink shared channel (PDSCH) performance.

35. The WTRU of claim 34, wherein the metric threshold comprises a measurement of a squared generalized cosine similarity (SGCS) between consecutive samples in the TSF buffer as compared to a TSF SGCS threshold.

36. The WTRU of claim 34, wherein the metric threshold comprises a measurement of a SGCS between first and last samples in the TSF buffer as compared to a TSF SGCS threshold.

37. The WTRU of claim 34, wherein the measure of WTRU speed is based on one or more of: an estimated Doppler, a feedback delay, or a CSI processing time.

38. The WTRU of claim 34, wherein the measure of PDSCH performance is based on one or more of: a measured block error rate (BLER) or a measured number of consecutive acknowledgments or negative acknowledgments (ACK/NACK).

39. The WTRU of claim 31, wherein the processor is further configured to:
store the measured CSI in a TSF buffer.

40. The WTRU of claim 39, wherein the TSF buffer contains at least one of: one or more eigenvector samples, or one or more full CSI samples.
